(19) United States
(12) Patent Application Publication
(10) Pub. No.: US 2012/0178635 A1
(43) Pub. Date: Jul. 12, 2012

(54) COMPOSITIONS AND METHODS FOR IDENTIFYING AND DETECTING SITES OF TRANSLOCATION AND DNA FUSION JUNCTIONS

(75) Inventors: Anindya Dutta, Charlottesville, VA (US); Yoshiyuki Shibata, Charlottesville, VA (US); Ankit Malhotra, Charlottesville, VA (US)

(73) Assignee: UNIVERSITY OF VIRGINIA PATENT FOUNDATION, Charlottesville, VA (US)

(21) Appl. No.: 13/389,261

(22) PCT Filed: Aug. 6, 2010
(86) PCT No.: PCT/US10/44676

§ 371 Date: Mar. 29, 2012

Related U.S. Application Data
(60) Provisional application No. 61/231,706, filed on Aug. 6, 2009.
(60) Provisional application No. 61/231,715, filed on Aug. 6, 2009.
(60) Provisional application No. 61/324,951, filed on Apr. 16, 2010.

(51) Int. Cl. C40B 20/04; G06F 19/00; C40B 70/00

(52) U.S. Cl. 506/4; 506/41; 702/19

(57) ABSTRACT

The present invention provides a powerful technique based on ultra high-throughput sequencing that finds structural aberrations of chromosomes and defines breakpoints. It is disclosed herein that, Anchored ChromPET, a technique to capture and interrogate targeted sequences in the genome, is a cost-effective means to identify chromosomal aberrations and define breakpoints. Using this method, we defined the BCR-ABL1 translocation DNA breakpoint to a base-pair resolution in Philadelphia chromosome positive cell lines and patient cells. This DNA-based method is highly sensitive and can detect signal using samples from which it is hard to obtain RNA or cells where the RNA expression has been silenced. These data demonstrate that ChromPET is a cost-effective and powerful technology that can identify and follow the appearance of chromosomal aberrations in various organisms, including, but not limited to, humans.

### CROSS REFERENCE TO RELATED APPLICATIONS

This application claims priority under 35 U.S.C. §119(e) to U.S. Provisional Application Ser. Nos. 61/231,706 filed Aug. 6, 2009, 61/231,715 filed Aug. 6, 2009, and 61/324,951 filed Apr. 16, 2010, the disclosures of which are incorporated by reference in their entirety herein.

### STATEMENT REGARDING FEDERALLY SPONSORED RESEARCH OR DEVELOPMENT

This invention was made in part with United States Government support under Grant Nos. R01 CA60499 and CA89406 awarded by The National Institutes of Health. The United States Government has certain rights in the invention.

### BACKGROUND

Chromosomal translocations play a major role in several genetic diseases. Translocations between genes have the potential to constitutively express or repress genes and hence lead to different diseases. The Philadelphia chromosome is a prime example of such a translocation where a fusion gene is constitutively expressed and leads to a particular class of leukemia. There are other translocations that have been implicated in cancers and other genetic diseases, and more are being discovered every day. A method that can quickly and robustly characterize specific translocations and produce DNA-based disease-specific biomarkers will have both diagnostic and prognostic applications. A method that is not dependent on growth of cells in culture will bring the power of cytogenetics to many more cancers.

The incidence of chronic myeloid leukemia (CML) is 1 to 2 per 100,000 and the disease constitutes 15-20% of adult leukemias. CML is characterized by the Philadelphia chromosome (Ph), resulting from the t(9; 22)(q34; q11) balanced reciprocal translocation. The translocation generates the BCR-ABL1 fusion protein with constitutive kinase activity and oncogenic activity. The breakpoints in the ABL1 gene lie in a 90 kb long intron 1, upstream from the ABL1 tyrosine kinase domains encoded in exons 2-11. The breakpoints within BCR are mapped to a 5.8 kilobase area spanning exons 12-16, the major breakpoint cluster region (M-bcr), found in 90% patients with CML and in 20-30% of Ph-positive B-cell acute lymphoblastic leukemia (Ph+B-ALL) [1][2][3].

Detection of Ph or BCR-ABL1 transcripts establishes a diagnosis of CML or Ph+B-ALL. The majority of CML patients are in chronic phase of disease when they have their blood tested for diagnosis. Most patients in the chronic phase are treated for extended periods of time by inhibitors of BCR-ABL1 tyrosine kinase such as imatinib mesylate [4][5][6]. These patients must be monitored continuously to follow the response to drugs and to ensure that disease does not recur. Generally, a white blood cell count is performed as a routine laboratory examination. A chemical profile also gives important information. However, cytogenetics is still considered the gold standard for diagnosing CML and evaluating response to therapy. There are two major forms for cytogenetic testing. Karyotyping requires condensation of chromosomes and thus requires cells undergoing mitosis. Therefore karyotyping is usually done on bone marrow (BM) aspirates, with the cells being cultured for several days to increase their number and to ensure active cell cycling before arrest in metaphase. The in vitro cell culture step is essential for karyotyping. Another way for cytogenetic testing is fluorescent in situ hybridization (FISH), which can be applied to nondividing cells isolated from peripheral blood. FISH is able to detect BCR-ABL1 translocation directly with fluorescent-labeled DNA probes and allows the detection of the BCR-ABL1 fusion gene in some cytogenetically Ph-negative cases with microscopically invisible rearrangements of chromosomes 9 and 22 [7][8][9][10]. However, neither karyotyping nor interphase FISH yields a sensitive and convenient molecular biomarker that can be used to follow up the patients during treatment.

Real-time reverse transcription PCR (RT-PCR) is the most sensitive technique available for the detection of BCR-ABL1 transcripts and is used to follow the progression of CML after initial diagnosis and treatment [11]. Although RT-PCR detects BCR-ABL1 transcripts from a small number of cells, the quality and efficiency of RNA extraction and/or reverse transcription affect the result. False negative cases may arise from degradation of the RNA following the harvesting of patient cells or from repression of the BCR-ABL1 transcript. In fact, an important question in the treatment of CML is whether a negative result in the RT-PCR test means that the patient is truly free of the disease and can be taken off imatinib treatment. Mattarucchi et al. reported the persistence of leukemic DNA even with undetectable levels of chimeric transcript [12]. Thus, a DNA-based marker of the translocation will facilitate patient management by confirming the absence of leukemic DNA. In addition, genetic heterogeneity is known among patients with CML and it is unclear whether the chromosomal translocation breakpoint influences disease progression because there has not been an easy method to sequence such breakpoints [13].

There is a long felt need in the art for new methods of detecting chromosomal aberrancies, including, but not limited to rearrangements, translocations, deletions, and insertions. The present invention satisfies these needs.

### SUMMARY OF THE INVENTION

The present invention provides compositions and methods useful for identifying structural variations in DNA and for identifying biomarkers associated with diseases and disease and disorders.

Disclosed herein is a method for detecting and monitoring the BCR-ABL1 translocation based on a screen for the DNA breakpoint. As demonstrated previously, paired-end tags (PET) technology is a powerful technique to identify unconventional fusion transcripts and structural variations in the genome [14][15][16][17][18]. However, a genome-wide approach to detect the BCR-ABL1 translocation for CML diagnosis is still too costly in both time and money. Anchored ChromPET combines three critical techniques, capture of targeted region to selectively enrich the region of interest, ChromPET sequencing to interrogate the genomic locus, and bar coding to multiplex multiple samples into a single ultra high-throughput sequencing lane. Using M-bcr as a model, demonstrated herein is the usefulness of this technique to obtain the sequence of the BCR-ABL1 DNA translocation junction from multiple samples in a single lane of the Illumina genome analyser II (GA-II). The high resolution of breakpoint identification, production of a patient-specific DNA biomarker and stability of DNA relative to RNA suggest that Anchored ChromPET will be useful for the detection and follow-up of diseases such as CML that are caused by specific chromosomal translocations.

In one aspect, the method provides for detecting and monitoring structural variations on a chromosome. In one aspect, the method provides for detecting and monitoring structural variations in DNA. In one aspect, the structural variations include, but are not limited to, a gene or nucleic acid translocation, rearrangements, insertions, deletions, copy number changes, etc., based on a screen for the DNA breakpoint using the methods of the invention. In one aspect, the method of the invention provides for capturing a targeted region to selectively enrich the region of interest, and then ChromPET sequencing to interrogate the genomic locus, and then bar coding to multiplex multiple samples into a single ultra high-throughput sequencing lane. In one aspect, the method provides for the identification of a subject-specific DNA biomarker.

In one aspect, the Anchored ChromPET method of the invention provides for the precise identification of the breakpoints on DNA. In one aspect, the precise identification of the breakpoints allows for optimal design of PCR primers. In one aspect, the PCR primers are designed for a DNA-based biomarker of a translocation junction. In one aspect, the Anchored ChromPET method of the invention is useful for detecting gene rearrangements. In one aspect, the algorithm of the invention is useful for predicting breakpoints.

The method of the present invention comprises preparing a ChromPET library by isolating or obtaining genomic DNA, fragmenting the DNA and then adding Y-shaped adapters containing bar codes to both ends of the fragments. In one aspect, paired-end tags are used. In one aspect, the DNA fragments used are about 0.5 kb fragments. One of ordinary skill in the art will appreciate that in some cases the fragment size can be varied. In one aspect, the bar codes are about 4 bp. One of ordinary skill in the art will appreciate that in some case the length and sequence of the bar code can be changed. The Y-shaped adapter ligated DNA is amplified by PCR. In one aspect, RNA bait is prepared by preparing DNA from a specific region of interest and converting into RNA bait by in vitro transcription. In one aspect, an Anchored ChromPET library is prepared by hybridizing the RNA bait to a ChromPET library that has been heat-denatured, capturing the RNA-DNA hybrids, washing away the RNA and converting the DNA to double-stranded DNA.

In one aspect, each ChromPET is identified using the bar code based on the paired-end tag reads obtained from a sequencer and then mapped to a target region using an alignment program. In one aspect, the alignment program is the Novocraft Novoalign program. In one aspect, a sequence of interest, such as the mBCR locus, is extracted and indexed using an indexing program, followed by mapping. In one aspect, the indexing program is the Novoindex program. In one aspect, the paired-end tags are about 38 bp. In one aspect, a bioinformatic pipeline is used to identify ChromPETs that have both tags mapping back uniquely to the target region. In one aspect, the ChromPETs are classified into normal ChromPETs (such as in mapping BCR-BCR and ABL1-ABL-1) and into aberrant ChromPETs, including junctional ChromPETs (such as BCR-ABL1 or ABL1-BCR).

In one aspect, the junctional ChromPETs for ABL1-BCR and BCR-ABL1 are selected from the group consisting of SEQ ID NOs:35-41. In one aspect, the 3′ end of BCR in BCR-ABL1 fusion (chr22:23,632,350-23,632,850) is SEQ ID NO.: 42. In one aspect, the 5′ end of BCR in ABL1-BCR fusion (chr22:23,632,613-23,633,084) is SEQ ID NO.: 43.

In one aspect, an algorithm is used for breakpoint prediction. In one aspect, the algorithm for breakpoint detection is based on a voting procedure. In one aspect, each junctional ChromPET is allowed to vote on the location of the actual breakpoint. In one aspect, normal ChromPETs are used to estimate the average and standard deviation of fragment lengths. In one aspect, using these estimates each tag of a junctional ChromPET votes on the likely location of the breakpoint. In one aspect, a vote of 3 is to the interval that is the average fragment length downstream from the start of the tag. In one aspect, a vote of 2 is to the interval one standard deviation down from the end of the 3 zone. In one aspect, a vote of 1 is to the interval another standard deviation downstream from the 2 zone. In one aspect, all votes are totaled and plotted over the locus of interest (such as over BCR or ABL), and the region with the maximum votes contains the predicted breakpoint. In one aspect, DNA primers are designed to amplify the junctional fragment by encompassing the predicted breakpoint-containing region.

In one embodiment, the methods of the invention encompass the use of ChromPET technology to identify a junction of chromosomal arrangement. In one aspect, the methods of the invention allow for the identification of chromosomal disruptions by insertion, deletion, or copy number. In one aspect, the ChromPET method is useful for detecting rearrangements involving repeat elements.

The methods of the invention are not limited to human DNA. The methods of the invention are useful in animals, as well as in microorganisms. For example, the present invention is also useful in yeast genome analysis, as disclosed herein and in U.S. provisional patent application 61/231,715 (filed Aug. 6, 2009), to which the present application claims priority. Additionally, the content of U.S. provisional patent application 61/231,715 has now published as Shibata et al., Nucleic Acids Research, 2009, 37:19:6454-6465 (published online Aug. 26, 2009).

In one embodiment, the present invention provides compositions and methods to perform a parallel bioinformatics approach to analyze chromosomal paired-end tag (ChromPET) sequence data to analyze sequences and sequence changes, including, but not limited to, changes due to gene rearrangements, chromosomal rearrangements, chromosomal translocations, deletions, and insertions.

In one aspect, the present invention provides for the use of multiple independent paired-end tags to report on an aberrant linkage, to overcome the issues of the short length of the tags, the presence of repeat sequences in the genome, and the expected level of abnormally mapping ChromPETs from chimera products produced by intermolecular ligation between genomic fragments during library construction. In one aspect, to identify such sites the distribution of all ChromPET tags and abnormal ChromPET tags can be calculated in about 2000 bp sliding windows with a slide of about 200 bases across the entire genome, or area of interest. The density of abnormal tags and the density of the abnormal to all tag ratio can be determined. Sites with a high density of abnormal tags and abnormal to all tag ration can be flagged as regions dense in abnormal tags and individually examined.

The methods of the invention are summarized schematically in part in FIG. 1D, where it is indicated the a ChromPET library is identified using the bar code sequence that was attached to the DNA, the set of ChromPETs is mapped to the target sequence(s) of interest, ChromPETs are classified and junctional ChromPETs are identified, junctional ChromPETs are then re-mapped back to the genome, and the breakpoints are predicted and profiles generated.

In one embodiment, the methods of the invention are useful for identifying DNA-based disease and disorder specific biomarkers. In one aspect, these biomarkers are useful for diagnostic purposes. In another aspect, these biomarkers are useful for prognostic purposes. In one aspect, the disease is cancer. In one aspect, the cancer is CML. In one aspect, the cancer is Ph+B-ALL. In one aspect, the cancer is Burkitt's lymphoma.

In one aspect, these markers are useful for monitoring the progression of a disease or disorder and for monitoring the treatment of a disease or disorder. The present inventions provides method for monitoring the progression of a disease or disorder in a subject wherein the disease or disorder is associated with a structural variation in a chromosome. The method comprises measuring the level of the structural variation in a sample from a test subject and comparing the level in the test subject to the level of the structural variation in an otherwise identical sample obtained earlier from the test subject. One of ordinary skill in the art will appreciate that the level could also be compared to the level in an unaffected subject or to a standard sample. In one aspect, the disease or disorder is cancer. In one aspect, the cancer is leukemia. In one aspect, the leukemia is CML or Ph+B-ALL. In one aspect, the test subject is being treated for the disease or disorder. In one aspect, a higher level of the structural variation in the test subject is an indication that the disease or disorder is progressing. A lower level of the structural variation in the test subject is an indication that the disease or disorder is regressing.

A cancer may belong to any of a group of cancers which have been described. Examples of such groups include, but are not limited to, leukemias, lymphomas, meningiomas, mixed tumors of salivary glands, adenomas, carcinomas, adenocarcinomas, sarcomas, dysgerminomas, retinoblastomas, Wilms' tumors, neuroblastomas, melanomas, and mesotheliomas.

In one aspect, the area of interest for anchoring the ChromPETs for diagnostic purposes can be selected based on the literature (e.g., Bcr-Abl translocation or IgH-Myc). In one aspect, the area of interest for anchoring the ChromPETs can be selected de novo by array Comparative Genome Hybridization (Array CGH) of cancer genomic DNA. Array CGH reveals islands of copy number alteration of genomic DNA. The junctions between the islands of amplification or deletion and normal chromosomal DNA can be discerned to a resolution of tens to hundreds of kilobases, a resolution that is not suitable for conversion to PCR based molecular biomarkers.

The present invention further provides for the use of the junctions identified herein for use in diagnostics and for biomarkers (SEQ ID NOs:35-43), as well as other junctions which can be identified using the methods of the invention.

In one embodiment, the invention provides a kit for identifying and monitoring chromosomal structural variations. The kit may comprise, for example: a list of reagents for pre-treatment of selected DNA sites for anchoring; polymerase chain reaction reagents; primer sequences; a list of reagents for sequencing; instructions and reagents for making the DNA library for paired end tag sequencing; DNA sequence based bar codes to distinguish libraries from different patients; list of materials for computational platform; algorithm for searching the ChromPET sequences to identify translocation junctions; primers to PCR amplify the translocation junction and sequence the junctional fragments for confirmation; and an instructional material for the use thereof.

For the purpose of illustrating the invention, there are depicted in the drawings certain embodiments of the invention. However, the invention is not limited to the precise arrangements and instrumentalities of the embodiments depicted in the drawings.

### BRIEF DESCRIPTION OF THE DRAWINGS

FIG. 1. Outline of Anchored ChromPET method. Details are in materials and methods. (A) Y-primers containing the sequencing primer and the bar code (1, 2 or 3) ligated to sized genomic fragments. (B) RNA bait for anchoring the targeted region prepared by cloning the fragments in a Top-TA vector and in-vitro transcription-translation. (C) Y-primed library is selected on the RNA bait, eluted, and amplified with PE primers to create the bar coded libraries for paired end sequencing. (D) Bioinformatics pipeline with sequence data.

FIG. 2. Predicted junctions between chromosome 9 and 22. BCR-ABL translocation alone was detected in K562 (A), but both BCR-ABL and ABL-BCR translocations were detected in the KU812 cells and two patient samples. Details of the junctions are in FIG. S4.

FIG. 3. Validation of predicted breakpoints in cell lines by PCR and Sanger sequencing. (A) Confirmation of chromosome rearrangements by PCR. Primer pair (K562DF1 and R1) yielded a junctional DNA fragment using genomic DNA from K562 (lane 2) but not from normal lung tissues (lane 4). This primer set failed to amplify DNA fragment using genomic DNA from KU812. PCR primer sets (KU812DF1, R1 and DF3, R3) amplified junctional DNA fragments using genomic DNA prepared from KU812 (lane 5, 7) but not from normal lung tissues (lane 6, 8). (B) Each PCR amplified junctional DNA fragment was cloned into plasmid vector and Sanger sequencing performed. Solid lines enclose BCR region and broken lines enclose ABL1 region. In K562, a microhomology (GAGTG) exists on the BCR and ABL sides of the breakpoint, so that we assume that the ligation point was somewhere in this GAGTG sequence.

FIG. 4. Validation of predicted breakpoints in patient samples by PCR and Sanger sequencing. (A) Amplified junctional DNA fragments using CML DNA from patient-1, -2, or -3 as template. PCR with primer sets (PhS1F9, R9 and PhS1F2.2, R2.2) successfully amplified DNA fragment from patient-1 DNA (lane 2, 4) but not from patient-3 (lane 10, 11). Primer sets (PhS2F1.1, R1.2 and PhS2F2.2, R2.2) gave product from patient-2 DNA (lane 6, 8). The junctional DNA fragment was not detected using genomic DNA from normal lung tissue (lane 3, 5, 7, 9). Asterisks indicated unique fragments observed in patient's samples. (B) Each PCR amplified DNA fragment was cloned into plasmid vector and then sequenced. Solid lines enclose BCR region and broken lines enclose ABL1 region.

FIG. 5. Sensitivity of detection of DNA junctional fragment. (A) All six samples contained 1×10⁶ cells each, but with a ten-fold serial dilution of K562 cells mixed with appropriate number of HCT116 cells. So the number of K562 cells are 10⁶ (no dilution), 10⁵ (1:10), 10⁴ (1:100), 10³ (1:1,000), 10² (1:10,000) and 0. Total genomic DNA (100 ng) was used as a template for real-time PCR reaction using PCR primer set K562DF3 and R3. The Q-PCR signal was normalized to PCR product from the PCNA locus. Simultaneously we isolated total RNA with TRIzol. cDNA reverse transcribed by SuperScript III from 100 ng of total RNA was used as a template for real-time PCR reaction. (B) Genomic DNA and RNA were extracted from 10⁶ formalin fixed KU812 cells. Real-time PCR reaction (primer sets KU812DF3, R3 and BCRe13F1, ABL1a2R1) was performed using DNA or cDNA from 10⁴ cells and normalized to DNA or cDNA from 10³ freshly prepared cells. (C) DNA and RNA were prepared from KU812 cell culture medium. DNA or cDNA from 100 ul medium was used for assay and normalized as above.

FIG. S1. Evaluation of capture efficiencies by quantitative real time PCR. ChromPET (original) and Anchored ChromPET (captured) libraries prepared from each patient's DNA were used for the evaluation of capture efficiency. PCR primer set (M-BCR—F2 and R2) mapping to the 5′ region of M-bcr was used for this experiment. Each signal was normalized to the signal from the PCNA locus (primer set hPCNA-F1 and R1). The target region in patient samples were enriched from 5,800 to 17,000-fold.

FIG. S2. A depiction of the algorithm for breakpoint prediction. (A) All tags mapped to the region of interest are identified along with their orientation; (B) Each tag contributes a decreasing vote to basepairs downstream of the tag, the vote decrease the farther one is from the starting position of the tag; (C) All votes are aggregated over the region and the region with the maximum votes is called the predicted breakpoint.

FIG. S3 (comprising FIGS. S3A-S3D). Predicted and actual breakpoints. UCSC genome browser snapshots from the Cell Lines for (A) the M-bcr locus and (B) ABL1 locus, indicating the predicted breakpoint location and the position of the sequenced breakpoints. (C) M-bcr locus and (D) ABL1 locus showing similar information for the three patient samples. The absence of a single dominant predicted breakpoint in patient sample 3 alerted us to the possibility of a contamination leading to the contaminating junctional ChromPETs.

FIG. S4. Reciprocal translocation breakpoints. chr22:23,632,613-23,632,850 region of BCR gene in KU812, chr22:23,632,193-23,632,332 region of BCR gene in patient-1, and chr9:133,681,793-133,681,794 region in ABL1 gene in patient-2 were duplicated. 1 bp deletion (chr22:23,632,386) was found in BCR breakpoint in patient-2. Light gray thick lines: part of BCR-ABL1 fusion gene. Black thick line: part of ABL1-BCR fusion gene. Dark gray thick line: part that is represented in both fusions and so indicates a duplication. Thin line: deletion. Lines with arrows: junction for BCR-ABL1 (downward arrow) or ABL1-BCR (upward arrow) fusion genes.

FIG. S5A. Duplicated sequence observed in M-bcr in KU812. 3′ end of upper sequence indicates the breakpoint in BCR-ABL1 fusion gene and 5′ end of lower sequence shows the breakpoint in ABL1-BCR fusion gene. 238 bp area (chr22:23,632,613-23,632,850) contained in solid line was duplicated in KU812 and present in both fusion genes.

FIG. S5B. Secondary DNA structure of the sequence that was duplicated in the BCR locus and present in both BCR-ABL and ABL-BCR fusion in KU812 cells. Sequence was computed by DNA mfold. The Gibbs free energy (dG) of this region was −88.96 kcal/mol.

FIG. S5C. A model for the hairpin-mediated replication fork stalling, asymmetric break on the two strands and sequence duplication. Light gray thick lines: regions forming cruciform structures. Gray circles: DNA replication machinery. Arrows: leading or lagging strand. Arrowheads: asymmetric breaks in the two strands.

### DETAILED DESCRIPTION OF THE INVENTION

### Abbreviations and Acronyms

### ACP—Anchored ChromPETs

Array CGH—array Comparative Genome Hybridization; also “aCGH”
B-ALL—B-cell acute lymphoblastic leukemia
BM—bone marrow

### CGH—Comparative Genome Hybridization

ChromPETs—chromosomal paired-end tags
CML—chronic myeloid leukemia
FISH—fluorescent in situ hybridization
GA-II—genome analyser II
GCR—gross chromosomal rearrangements

### GST—Genomic Signature Tags

### GVT—Genomic Variation Tag

HDW—high density window
LAHS—left-arm transposition hot-spot
M-bcr—major breakpoint cluster region
MAD—median absolute deviation
MLW—maximum linkage window
PCR—polymerase chain reaction
PETs—paired-end tags
Ph—Philadelphia chromosome
Ph+B-ALL—Ph-positive B-cell acute lymphoblastic leukemia
RAHS—right-arm transposition hot-spot
RT-PCR—real time reverse transcription PCR

### SAGE—Serial Analysis of Gene Expression

### DEFINITIONS

In describing and claiming the invention, the following terminology will be used in accordance with the definitions set forth below. Unless defined otherwise, all technical and scientific terms used herein have the commonly understood meaning by one of ordinary skill in the art to which the invention pertains. Although any methods and materials similar or equivalent to those described herein may be useful in the practice or testing of the present invention, preferred methods and materials are described below. Specific terminology of particular importance to the description of the present invention is defined below.

The articles “a” and “an” are used herein to refer to one or to more than one (i.e., to at least one) of the grammatical object of the article. By way of example, “an element” means one element or more than one element.

The term “about,” as used herein, means approximately, in the region of, roughly, or around. When the term “about” is used in conjunction with a numerical range, it modifies that range by extending the boundaries above and below the numerical values set forth. For example, in one aspect, the term “about” is used herein to modify a numerical value above and below the stated value by a variance of 20%.

As used herein, the term “adjacent” is used to refer to nucleotide sequences which are directly attached to one another, having no intervening nucleotides. By way of example, the pentanucleotide 5′-AAAAA-3′ is adjacent the trinucleotide 5′-TTT-3′ when the two are connected thus: 5′-AAAAATTT-3′ or 5′-TTTAAAAA-3′, but not when the two are connected thus: 5′-AAAAACTTT-3′.

A disease, disorder, or condition is “alleviated” if the severity of a symptom of the disease or disorder, the frequency with which such a symptom is experienced by a patient, or both, are reduced.

The term “alterations in peptide structure” as used herein refers to changes including, but not limited to, changes in sequence, and post-translational modification.

As used herein, “amino acids” are represented by the full name thereof, by the three letter code corresponding thereto, or by the one-letter code corresponding thereto, as indicated in the following table:

| Full Name | Three-Letter Code | One-Letter Code |
|---|---|---|
| Aspartic Acid | Asp | D |
| Glutamic Acid | Glu | E |
| Lysine | Lys | K |
| Arginine | Arg | R |
| Histidine | His | H |
| Tyrosine | Tyr | Y |
| Cysteine | Cys | C |
| Asparagine | Asn | N |
| Glutamine | Gln | Q |
| Serine | Ser | S |
| Threonine | Thr | T |
| Glycine | Gly | G |
| Alanine | Ala | A |
| Valine | Val | V |
| Leucine | Leu | L |
| Isoleucine | Ile | I |
| Methionine | Met | M |
| Proline | Pro | P |
| Phenylalanine | Phe | F |
| Tryptophan | Trp | W |

The expression “amino acid” as used herein is meant to include both natural and synthetic amino acids, and both D and L amino acids. “Standard amino acid” means any of the twenty standard L-amino acids commonly found in naturally occurring peptides. “Nonstandard amino acid residue” means any amino acid, other than the standard amino acids, regardless of whether it is prepared synthetically or derived from a natural source. As used herein, “synthetic amino acid” also encompasses chemically modified amino acids, including but not limited to salts, amino acid derivatives (such as amides), and substitutions Amino acids contained within the peptides of the present invention, and particularly at the carboxy- or amino-terminus, can be modified by methylation, amidation, acetylation or substitution with other chemical groups which can change the peptide's circulating half-life without adversely affecting their activity. Additionally, a disulfide linkage may be present or absent in the peptides of the invention.

The term “amino acid” is used interchangeably with “amino acid residue,” and may refer to a free amino acid and to an amino acid residue of a peptide. It will be apparent from the context in which the term is used whether it refers to a free amino acid or a residue of a peptide.

Amino acids have the following general structure:

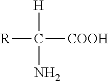

Amino acids may be classified into seven groups on the basis of the side chain R: (1) aliphatic side chains, (2) side chains containing a hydroxylic (OH) group, (3) side chains containing sulfur atoms, (4) side chains containing an acidic or amide group, (5) side chains containing a basic group, (6) side chains containing an aromatic ring, and (7) proline, an imino acid in which the side chain is fused to the amino group.

The nomenclature used to describe the peptide compounds of the present invention follows the conventional practice wherein the amino group is presented to the left and the carboxy group to the right of each amino acid residue. In the formulae representing selected specific embodiments of the present invention, the amino- and carboxy-terminal groups, although not specifically shown, will be understood to be in the form they would assume at physiologic pH values, unless otherwise specified.

“Amplification” refers to any means by which a polynucleotide sequence is copied and thus expanded into a larger number of polynucleotide molecules, e.g., by reverse transcription, polymerase chain reaction, and ligase chain reaction.

As used herein, an “analog” of a chemical compound is a compound that, by way of example, resembles another in structure but is not necessarily an isomer (e.g., 5-fluorouracil is an analog of thymine).

The term “analyte”, as used herein, refers to any material or chemical substance subjected to analysis. In one aspect, the material is a peptide or mixture of peptides. In another aspect, the term refers to a mixture of biomolecules, including, but not limited to, lipids, carbohydrates, and nucleic acids such as DNA and RNA. The term “anchor”, as used herein, means to purify DNA or cDNA from a particular part of the genome so that the subsequent steps (in this case, ultrahigh throughput paired-end-sequencing) can be restricted to that particular part of the genome. This allows more samples to be covered than if the whole genome was processed. The present applications discloses a novel method of anchoring that can be used for other applications as well, not just identifying structural variations in the genome.

The term “Anchored ChromPET”, as used herein, refers to the chromosomal paired end reads done only on the parts of the genome that are selectively purified using the anchoring step of the invention. The mapping of the paired-end-tags back to the genome is thus simplified and it becomes easier to find the structural variations in the chromosomes.

The term “antibody,” as used herein, refers to an immunoglobulin molecule which is able to specifically bind to a specific epitope on an antigen. Antibodies can be intact immunoglobulins derived from natural sources or from recombinant sources and can be immunoreactive portions of intact immunoglobulins. Antibodies are typically tetramers of immunoglobulin molecules. The antibodies in the present invention may exist in a variety of forms including, for example, polyclonal antibodies, monoclonal antibodies, Fv, Fab and F(ab)2, as well as single chain antibodies and humanized antibodies (Harlow et al., 1999, Using Antibodies: A Laboratory Manual, Cold Spring Harbor Laboratory Press, NY; Harlow et al., 1989, Antibodies: A Laboratory Manual, Cold Spring Harbor, N.Y.; Houston et al., 1988, Proc. Natl. Acad. Sci. USA 85:5879-5883; Bird et al., 1988, Science 242:423-426).

By the term “synthetic antibody” as used herein, is meant an antibody which is generated using recombinant DNA technology, such as, for example, an antibody expressed by a bacteriophage as described herein. The term should also be construed to mean an antibody which has been generated by the synthesis of a DNA molecule encoding the antibody and which DNA molecule expresses an antibody protein, or an amino acid sequence specifying the antibody, wherein the DNA or amino acid sequence has been obtained using synthetic DNA or amino acid sequence technology which is available and well known in the art.

A first nucleic acid region and a second nucleic acid region are “arranged in an antiparallel fashion” if, when the first region is fixed in space and extends in a direction from its 5′-end to its 3′-end, at least a portion of the second region lies parallel to the first strand and extends in the same direction from its 3′-end to its 5′-end.

As used herein, the term “antisense oligonucleotide” means a nucleic acid polymer, at least a portion of which is complementary to a nucleic acid which is present in a normal cell or in an affected cell. The antisense oligonucleotides of the invention include, but are not limited to, phosphorothioate oligonucleotides and other modifications of oligonucleotides. Methods for synthesizing oligonucleotides, phosphorothioate oligonucleotides, and otherwise modified oligonucleotides are well known in the art (U.S. Pat. No. 5,034,506; Nielsen et al., 1991, Science 254: 1497).

“Antisense” refers particularly to the nucleic acid sequence of the non-coding strand of a double stranded DNA molecule encoding a protein, or to a sequence which is substantially homologous to the non-coding strand. As defined herein, an antisense sequence is complementary to the sequence of a double stranded DNA molecule encoding a protein. It is not necessary that the antisense sequence be complementary solely to the coding portion of the coding strand of the DNA molecule. The antisense sequence may be complementary to regulatory sequences specified on the coding strand of a DNA molecule encoding a protein, which regulatory sequences control expression of the coding sequences.

The term “basic” or “positively charged” amino acid as used herein, refers to amino acids in which the R groups have a net positive charge at pH 7.0, and include, but are not limited to, the standard amino acids lysine, arginine, and histidine.

The term “biocompatible”, as used herein, refers to a material that does not elicit a substantial detrimental response in the host.

As used herein, the term “biologically active fragments” or “bioactive fragment” of the polypeptides encompasses natural or synthetic portions of the full length protein that are capable of specific binding to their natural ligand or of performing the function of the protein.

The term “biomolecule”, as used herein, refers broadly to, inter alia, a molecule produced or used by a living organism, or which is a substituent of a living organism.

Biomolecules can be natural or synthetic. Biomolecules, include for example, but are not limited to, lipids, carbohydrates, proteins, peptides, and nucleic acids such as DNA and RNA.

The terms “cell,” “cell line,” and “cell culture” as used herein may be used interchangeably. All of these terms also include their progeny, which are any and all subsequent generations. It is understood that all progeny may not be identical due to deliberate or inadvertent mutations.

“Complementary” refers to the broad concept of sequence complementarity between regions of two nucleic acid strands or between two regions of the same nucleic acid strand. It is known that an adenine residue of a first nucleic acid region is capable of forming specific hydrogen bonds (“base pairing”) with a residue of a second nucleic acid region which is antiparallel to the first region if the residue is thymine or uracil. As used herein, the terms “complementary” or “complementarity” are used in reference to polynucleotides (i.e., a sequence of nucleotides) related by the base pairing rules. For example, for the sequence “A G T,” is complementary to the sequence “T C A.” Similarly, it is known that a cytosine residue of a first nucleic acid strand is capable of base pairing with a residue of a second nucleic acid strand which is antiparallel to the first strand if the residue is guanine. A first region of a nucleic acid is complementary to a second region of the same or a different nucleic acid if, when the two regions are arranged in an antiparallel fashion, at least one nucleotide residue of the first region is capable of base pairing with a residue of the second region. Preferably, the first region comprises a first portion and the second region comprises a second portion, whereby, when the first and second portions are arranged in an antiparallel fashion, at least about 50%, and preferably at least about 75%, at least about 90%, or at least about 95% of the nucleotide residues of the first portion are capable of base pairing with nucleotide residues in the second portion. More preferably, all nucleotide residues of the first portion are capable of base pairing with nucleotide residues in the second portion.

A “compound,” as used herein, refers to a protein, polypeptide, an isolated nucleic acid, or other agent used in the method of the invention.

As used herein, the term “conservative amino acid substitution” is defined herein as an amino acid exchange within one of the following five groups:

I. Small aliphatic, nonpolar or slightly polar residues:
Ala, Ser, Thr, Pro, Gly;

II. Polar, negatively charged residues and their amides:
Asp, Asn, Glu, Gln;

III. Polar, positively charged residues:
His, Arg, Lys;

IV. Large, aliphatic, nonpolar residues:
Met Leu, Ile, Val, Cys

V. Large, aromatic residues:
Phe, Tyr, Trp

A “control” cell, tissue, sample, or subject is a cell, tissue, sample, or subject of the same type as a test cell, tissue, sample, or subject. The control may, for example, be examined at precisely or nearly the same time the test cell, tissue, sample, or subject is examined. The control may also, for example, be examined at a time distant from the time at which the test cell, tissue, sample, or subject is examined, and the results of the examination of the control may be recorded so that the recorded results may be compared with results obtained by examination of a test cell, tissue, sample, or subject. The control may also be obtained from another source or similar source other than the test group or a test subject, where the test sample is obtained from a subject suspected of having a disease or disorder for which the test is being performed.

A “test” cell, tissue, sample, or subject is one being examined or treated.

A “pathoindicative” cell, tissue, or sample is one which, when present, is an indication that the animal in which the cell, tissue, or sample is located (or from which the tissue was obtained) is afflicted with a disease or disorder. By way of example, the presence of one or more breast cells in a lung tissue of an animal is an indication that the animal is afflicted with metastatic breast cancer.

A tissue “normally comprises” a cell if one or more of the cell are present in the tissue in an animal not afflicted with a disease or disorder.

The use of the word “detect” and its grammatical variants is meant to refer to measurement of the species without quantification, whereas use of the word “determine” or “measure” with their grammatical variants are meant to refer to measurement of the species with quantification. The terms “detect” and “identify” are used interchangeably herein.

As used herein, a “detectable marker” or a “reporter molecule” is an atom or a molecule that permits the specific detection of a compound comprising the marker in the presence of similar compounds without a marker. Detectable markers or reporter molecules include, e.g., radioactive isotopes, antigenic determinants, enzymes, nucleic acids available for hybridization, chromophores, fluorophores, chemiluminescent molecules, electrochemically detectable molecules, and molecules that provide for altered fluorescence polarization or altered light scattering.

A “disease” is a state of health of an animal wherein the animal cannot maintain homeostasis, and wherein if the disease is not ameliorated then the animal's health continues to deteriorate.

In contrast, a “disorder” in an animal is a state of health in which the animal is able to maintain homeostasis, but in which the animal's state of health is less favorable than it would be in the absence of the disorder. Left untreated, a disorder does not necessarily cause a further decrease in the animal's state of health.

“Encoding” refers to the inherent property of specific sequences of nucleotides in a polynucleotide, such as a gene, a cDNA, or an mRNA, to serve as templates for synthesis of other polymers and macromolecules in biological processes having either a defined sequence of nucleotides (i.e., rRNA, tRNA and mRNA) or a defined sequence of amino acids and the biological properties resulting therefrom. Thus, a gene encodes a protein if transcription and translation of mRNA corresponding to that gene produces the protein in a cell or other biological system. Both the coding strand, the nucleotide sequence of which is identical to the mRNA sequence and is usually provided in sequence listings, and the non-coding strand, used as the template for transcription of a gene or cDNA, can be referred to as encoding the protein or other product of that gene or cDNA.

Unless otherwise specified, a “nucleotide sequence encoding an amino acid sequence” includes all nucleotide sequences that are degenerate versions of each other and that encode the same amino acid sequence. Nucleotide sequences that encode proteins and RNA may include introns.

An “enhancer” is a DNA regulatory element that can increase the efficiency of transcription, regardless of the distance or orientation of the enhancer relative to the start site of transcription.

As used herein, an “essentially pure” preparation of a particular protein or peptide is a preparation wherein at least about 95%, and preferably at least about 99%, by weight, of the protein or peptide in the preparation is the particular protein or peptide.

As used in the specification and the appended claims, the terms “for example,” “for instance,” “such as,” “including” and the like are meant to introduce examples that further clarify more general subject matter. Unless otherwise specified, these examples are provided only as an aid for understanding the invention, and are not meant to be limiting in any fashion.

A “fragment” or “segment” is a portion of an amino acid sequence, comprising at least one amino acid, or a portion of a nucleic acid sequence comprising at least one nucleotide. The terms “fragment” and “segment” are used interchangeably herein.

As used herein, a “functional” biological molecule is a biological molecule in a form in which it exhibits a property or activity by which it is characterized. A functional enzyme, for example, is one which exhibits the characteristic catalytic activity by which the enzyme is characterized.

A “genomic DNA” of a human patient is a DNA strand which has a nucleotide sequence homologous with a gene of the patient. By way of example, both a fragment of a chromosome and a cDNA derived by reverse transcription of a human mRNA are genomic DNAs.

“Homologous” as used herein, refers to the subunit sequence similarity between two polymeric molecules, e.g., between two nucleic acid molecules, e.g., two DNA molecules or two RNA molecules, or between two polypeptide molecules. When a subunit position in both of the two molecules is occupied by the same monomeric subunit, e.g., if a position in each of two DNA molecules is occupied by adenine, then they are homologous at that position. The homology between two sequences is a direct function of the number of matching or homologous positions, e.g., if half (e.g., five positions in a polymer ten subunits in length) of the positions in two compound sequences are homologous then the two sequences are 50% homologous, if 90% of the positions, e.g., 9 of 10, are matched or homologous, the two sequences share 90% homology. By way of example, the DNA sequences 3′ATTGCC5′ and 3′TATGGC share 50% homology.

As used herein, “homology” is used synonymously with “identity” when comparing sequences.

As used herein, the term “hybridization” is used in reference to the pairing of complementary nucleic acids. Hybridization and the strength of hybridization (i.e., the strength of the association between the nucleic acids) is impacted by such factors as the degree of complementarity between the nucleic acids, stringency of the conditions involved, the length of the formed hybrid, and the G:C ratio within the nucleic acids.

The determination of percent identity between two nucleotide or amino acid sequences can be accomplished using a mathematical algorithm. For example, a mathematical algorithm useful for comparing two sequences is the algorithm of Karlin and Altschul (1990, Proc. Natl. Acad. Sci. USA 87:2264-2268), modified as in Karlin and Altschul (1993, Proc. Natl. Acad. Sci. USA 90:5873-5877). This algorithm is incorporated into the NBLAST and XBLAST programs of Altschul, et al. (1990, J. Mol. Biol. 215:403-410), and can be accessed, for example at the National Center for Biotechnology Information (NCBI) world wide web site. BLAST nucleotide searches can be performed with the NBLAST program (designated “blastn” at the NCBI web site), using the following parameters: gap penalty=5; gap extension penalty=2; mismatch penalty=3; match reward=1; expectation value 10.0; and word size=11 to obtain nucleotide sequences homologous to a nucleic acid described herein. BLAST protein searches can be performed with the XBLAST program (designated “blastn” at the NCBI web site) or the NCBI “blastp” program, using the following parameters: expectation value 10.0, BLOSUM62 scoring matrix to obtain amino acid sequences homologous to a protein molecule described herein. To obtain gapped alignments for comparison purposes, Gapped BLAST can be utilized as described in Altschul et al. (1997, Nucleic Acids Res. 25:3389-3402). Alternatively, PSI-Blast or PHI-Blast can be used to perform an iterated search which detects distant relationships between molecules (Id.) and relationships between molecules which share a common pattern. When utilizing BLAST, Gapped BLAST, PSI-Blast, and PHI-Blast programs, the default parameters of the respective programs (e.g., XBLAST and NBLAST) can be used.

The percent identity between two sequences can be determined using techniques similar to those described above, with or without allowing gaps. In calculating percent identity, typically exact matches are counted.

As used herein, an “instructional material” includes a publication, a recording, a diagram, or any other medium of expression which can be used to communicate the usefulness of the compositions and methods of the invention in the kit for identifying and monitoring structural variations in a chromosome. The instructional material of the kit of the invention may, for example, be affixed to a container which contains the identified compound invention or be shipped together with a container which contains the identified compound. Alternatively, the instructional material may be shipped separately from the container with the intention that the instructional material and the compound be used cooperatively by the recipient.

An “isolated nucleic acid” refers to a nucleic acid segment or fragment which has been separated from sequences which flank it in a naturally occurring state, e.g., a DNA fragment which has been removed from the sequences which are normally adjacent to the fragment, e.g., the sequences adjacent to the fragment in a genome in which it naturally occurs. The term also applies to nucleic acids which have been substantially purified from other components which naturally accompany the nucleic acid, e.g., RNA or DNA or proteins, which naturally accompany it in the cell. The term therefore includes, for example, a recombinant DNA which is incorporated into a vector, into an autonomously replicating plasmid or virus, or into the genomic DNA of a prokaryote or eukaryote, or which exists as a separate molecule (e.g., as a cDNA or a genomic or cDNA fragment produced by PCR or restriction enzyme digestion) independent of other sequences. It also includes a recombinant DNA which is part of a hybrid gene encoding additional polypeptide sequence. As used herein, the term “junctional ChromPET” refers to paired-end tags that span (map on either side of) a new junction created by the structural variations in the tumor DNA. The junction could be created by translocations, deletions or insertions and do not exist in the normal DNA.

Unless otherwise specified, a “nucleotide sequence encoding an amino acid sequence” includes all nucleotide sequences that are degenerate versions of each other and that encode the same amino acid sequence. Nucleotide sequences that encode proteins and RNA may include introns.

As used herein, a “ligand” is a compound that specifically binds to a target compound. A ligand (e.g., an antibody) “specifically binds to” or “is specifically immunoreactive with” a compound when the ligand functions in a binding reaction which is determinative of the presence of the compound in a sample of heterogeneous compounds. Thus, under designated assay (e.g., immunoassay) conditions, the ligand binds preferentially to a particular compound and does not bind to a significant extent to other compounds present in the sample. For example, an antibody specifically binds under immunoassay conditions to an antigen bearing an epitope against which the antibody was raised. A variety of immunoassay formats may be used to select antibodies specifically immunoreactive with a particular antigen. For example, solid-phase ELISA immunoassays are routinely used to select monoclonal antibodies specifically immunoreactive with an antigen. See Harlow and Lane, 1988, Antibodies, A Laboratory Manual, Cold Spring Harbor Publications, New York, for a description of immunoassay formats and conditions that can be used to determine specific immunoreactivity.

As used herein, the term “linkage” refers to a connection between two groups. The connection can be either covalent or non-covalent, including but not limited to ionic bonds, hydrogen bonding, and hydrophobic/hydrophilic interactions. As used herein, the term “linker” refers to a molecule that joins two other molecules either covalently or noncovalently, e.g., through ionic or hydrogen bonds or van der Waals interactions.

The term “mass tag”, as used herein, means a chemical modification of a molecule, or more typically two such modifications of molecules such as peptides, that can be distinguished from another modification based on molecular mass, despite chemical identity.

The term “method of identifying peptides in a sample”, as used herein, refers to identifying small and large peptides, including proteins.

By “nucleic acid” is meant any nucleic acid, whether composed of deoxyribonucleosides or ribonucleosides, and whether composed of phosphodiester linkages or modified linkages such as phosphotriester, phosphoramidate, siloxane, carbonate, carboxymethylester, acetamidate, carbamate, thioether, bridged phosphoramidate, bridged methylene phosphonate, bridged phosphoramidate, bridged phosphoramidate, bridged methylene phosphonate, phosphorothioate, methylphosphonate, phosphorodithioate, bridged phosphorothioate or sulfone linkages, and combinations of such linkages. The term nucleic acid also specifically includes nucleic acids composed of bases other than the five biologically occurring bases (adenine, guanine, thymine, cytosine, and uracil). Conventional notation is used herein to describe polynucleotide sequences: the left-hand end of a single-stranded polynucleotide sequence is the 5′-end; the left-hand direction of a double-stranded polynucleotide sequence is referred to as the 5′-direction. The direction of 5′ to 3′ addition of nucleotides to nascent RNA transcripts is referred to as the transcription direction. The DNA strand having the same sequence as an mRNA is referred to as the “coding strand”; sequences on the DNA strand which are located 5′ to a reference point on the DNA are referred to as “upstream sequences”; sequences on the DNA strand which are 3′ to a reference point on the DNA are referred to as “downstream sequences.”

The term “oligonucleotide” typically refers to short polynucleotides, generally no greater than about 50 nucleotides. It will be understood that when a nucleotide sequence is represented by a DNA sequence (i.e., A, T, G, C), this also includes an RNA sequence (i.e., A, U, G, C) in which “U” replaces “T.”

The term “otherwise identical sample”, as used herein, refers to a sample similar to a first sample, that is, it is obtained in the same manner from the same subject from the same tissue or fluid, or it refers a similar sample obtained from a different subject. The term “otherwise identical sample from an unaffected subject” refers to a sample obtained from a subject not known to have the disease or disorder being examined. The sample may of course be a standard sample.

A first nucleic acid region and a second nucleic acid region are “arranged in a parallel fashion” if, when the first region is fixed in space and extends in a direction from its 5′-end to its 3′-end, at least a portion of the second region lies parallel to the first strand and extends in the same direction from its 5′-end to its 3′-end.

As used herein, a “peptide” encompasses a sequence of 2 or more amino acid residues wherein the amino acids are naturally occurring or synthetic (non naturally occurring) amino acids covalently linked by peptide bonds. No limitation is placed on the number of amino acid residues which can comprise a protein's or peptide's sequence. As used herein, the terms “peptide,” polypeptide,” and “protein” are used interchangeably. Peptide mimetics include peptides having one or more of the following modifications:

1. peptides wherein one or more of the peptidyl C(O)NR linkages (bonds) have been replaced by a non peptidyl linkage such as a CH2 carbamate linkage (CH2OC(O)NR), a phosphonate linkage, a CH2 sulfonamide (CH2S(O)2NR) linkage, a urea (NHC(O)NH) linkage, a CH2 secondary amine linkage, or with an alkylated peptidyl linkage (C(O)NR) wherein R is C1 C4 alkyl;

2. peptides wherein the N terminus is derivatized to a NRR1 group, to a NRC(O)R group, to a NRC(O)OR group, to a NRS(O)₂R group, to a NHC(O)NHR group where R and R1 are hydrogen or C1 C4 alkyl with the proviso that R and R1 are not both hydrogen;

3. peptides wherein the C terminus is derivatized to C(O)R2 where R 2 is selected from the group consisting of C1 C4 alkoxy, and NR3R4 where R3 and R4 are independently selected from the group consisting of hydrogen and C1 C4 alkyl.

Synthetic or non naturally occurring amino acids refer to amino acids which do not naturally occur in vivo but which, nevertheless, can be incorporated into the peptide structures described herein. The resulting “synthetic peptide” contains amino acids other than the 20 naturally occurring, genetically encoded amino acids at one, two, or more positions of the peptides. For instance, naphthylalanine can be substituted for tryptophan to facilitate synthesis. Other synthetic amino acids that can be substituted into peptides include L hydroxypropyl, L 3,4 dihydroxyphenylalanyl, alpha amino acids such as L alpha hydroxylysyl and D alpha methylalanyl, L alpha. methylalanyl, beta. amino acids, and isoquinolyl. D amino acids and non naturally occurring synthetic amino acids can also be incorporated into the peptides. Other derivatives include replacement of the naturally occurring side chains of the 20 genetically encoded amino acids (or any L or D amino acid) with other side chains.

The term “peptide mass labeling”, as used herein, means the strategy of labeling peptides with two mass tag reagents that are chemically identical but differ by a distinguishing mass.

As used herein, the term “pharmaceutically acceptable carrier” includes any of the standard pharmaceutical carriers, such as a phosphate buffered saline solution, water, emulsions such as an oil/water or water/oil emulsion, and various types of wetting agents. The term also encompasses any of the agents approved by a regulatory agency of the US Federal government or listed in the US Pharmacopeia for use in animals, including humans.

A “polylinker” is a nucleic acid sequence that comprises a series of three or more different restriction endonuclease recognitions sequences closely spaced to one another (i.e. less than 10 nucleotides between each site).

A “polynucleotide” means a single strand or parallel and anti-parallel strands of a nucleic acid. Thus, a polynucleotide may be either a single-stranded or a double-stranded nucleic acid.

“Polypeptide” refers to a polymer composed of amino acid residues, related naturally occurring structural variants, and synthetic non-naturally occurring analogs thereof linked via peptide bonds, related naturally occurring structural variants, and synthetic non-naturally occurring analogs thereof. Synthetic polypeptides can be synthesized, for example, using an automated polypeptide synthesizer.

The term “protein” typically refers to large polypeptides.

Unless otherwise specified, a “nucleotide sequence encoding an amino acid sequence” includes all nucleotide sequences that are degenerate versions of each other and that encode the same amino acid sequence. Nucleotide sequences that encode proteins and RNA may include introns. “Plurality” means at least two.

As used herein, “protecting group” with respect to a terminal amino group refers to a terminal amino group of a peptide, which terminal amino group is coupled with any of various amino-terminal protecting groups traditionally employed in peptide synthesis. Such protecting groups include, for example, acyl protecting groups such as formyl, acetyl, benzoyl, trifluoroacetyl, succinyl, and methoxysuccinyl; aromatic urethane protecting groups such as benzyloxycarbonyl; and aliphatic urethane protecting groups, for example, tert-butoxycarbonyl or adamantyloxycarbonyl. See Gross and Mienhofer, eds., The Peptides, vol. 3, pp. 3-88 (Academic Press, New York, 1981) for suitable protecting groups.

As used herein, “protecting group” with respect to a terminal carboxy group refers to a terminal carboxyl group of a peptide, which terminal carboxyl group is coupled with any of various carboxyl-terminal protecting groups. Such protecting groups include, for example, tert-butyl, benzyl or other acceptable groups linked to the terminal carboxyl group through an ester or ether bond.

As used herein, the term “purified” and like terms relate to an enrichment of a molecule or compound relative to other components normally associated with the molecule or compound in a native environment. The term “purified” does not necessarily indicate that complete purity of the particular molecule has been achieved during the process. A “highly purified” compound as used herein refers to a compound that is greater than 90% pure.

“Recombinant polynucleotide” refers to a polynucleotide having sequences that are not naturally joined together. An amplified or assembled recombinant polynucleotide may be included in a suitable vector, and the vector can be used to transform a suitable host cell. A recombinant polynucleotide may serve a non-coding function (e.g., promoter, origin of replication, ribosome-binding site, etc.) as well.

A “recombinant polypeptide” is one which is produced upon expression of a recombinant polynucleotide.

A “sample,” as used herein, refers preferably to a biological sample from a subject, including, but not limited to, normal tissue samples, diseased tissue samples, biopsies, blood, saliva, feces, cerebrospinal fluid, semen, tears, and urine. A sample can also be any other source of material obtained from a subject which contains cells, tissues, or fluid of interest. A sample can also be obtained from cell or tissue culture. One of ordinary skill in the art will recognize that such a sample may comprise a complex mixture of peptides.

As used herein, the term “secondary antibody” refers to an antibody that binds to the constant region of another antibody (the primary antibody).

As used herein, the term “solid support” relates to a solvent insoluble substrate that is capable of forming linkages (preferably covalent bonds) with various compounds. The support can be either biological in nature, such as, without limitation, a cell or bacteriophage particle, or synthetic, such as, without limitation, an acrylamide derivative, agarose, cellulose, nylon, silica, or magnetized particles.

By the term “specifically binds,” as used herein, is meant an antibody or compound which recognizes and binds a molecule of interest (e.g., an antibody directed against a polypeptide of the invention), but does not substantially recognize or bind other molecules in a sample.

The term “standard,” as used herein, refers to something used for comparison. For example, a standard can be a known standard agent or compound which is administered or added to a control sample and used for comparing results when measuring said compound in a test sample. Standard can also refer to an “internal standard,” such as an agent or compound which is added at known amounts to a sample and is useful in determining such things as purification or recovery rates when a sample is processed or subjected to purification or extraction procedures before a marker of interest is measured. Standard can also refer to a standard sample which is used for comparison to a test sample.

By “structural variation in a chromosome” is meant a change such as an insertion, deletion, translocation, and copy number changes relative to what is considered normal DNA.

A “subject” of analysis, diagnosis, or treatment is an animal. Such animals include mammals, including humans. Non-human animals include, for example, pets and livestock, such as ovine, bovine, equine, porcine, canine, feline and murine mammals, as well as reptiles, birds and fish. The term “pets” refers to dogs, cats, marmosets, hamster, etc. Lower organisms are also included, for example, yeast.

As used herein, a “substantially homologous amino acid sequences” includes those amino acid sequences which have at least about 95% homology, preferably at least about 96% homology, more preferably at least about 97% homology, even more preferably at least about 98% homology, and most preferably at least about 99% or more homology to an amino acid sequence of a reference antibody chain Amino acid sequence similarity or identity can be computed by using the BLASTP and TBLASTN programs which employ the BLAST (basic local alignment search tool) 2.0.14 algorithm. The default settings used for these programs are suitable for identifying substantially similar amino acid sequences for purposes of the present invention.

“Substantially homologous nucleic acid sequence” means a nucleic acid sequence corresponding to a reference nucleic acid sequence wherein the corresponding sequence encodes a peptide having substantially the same structure and function as the peptide encoded by the reference nucleic acid sequence; e.g., where only changes in amino acids not significantly affecting the peptide function occur. Preferably, the substantially identical nucleic acid sequence encodes the peptide encoded by the reference nucleic acid sequence. The percentage of identity between the substantially similar nucleic acid sequence and the reference nucleic acid sequence is at least about 50%, 65%, 75%, 85%, 95%, 99% or more. Substantial identity of nucleic acid sequences can be determined by comparing the sequence identity of two sequences, for example by physical/chemical methods (i.e., hybridization) or by sequence alignment via computer algorithm. Suitable nucleic acid hybridization conditions to determine if a nucleotide sequence is substantially similar to a reference nucleotide sequence are: 7% sodium dodecyl sulfate SDS, 0.5 M NaPO₄, 1 mM EDTA at 50° C. with washing in 2×standard saline citrate (SSC), 0.1% SDS at 50° C.; preferably in 7% (SDS), 0.5 M NaPO₄, 1 mM EDTA at 50° C., with washing in 1×SSC, 0.1% SDS at 50° C.; preferably 7% SDS, 0.5 M NaPO₄, 1 mM EDTA at 50° C. with washing in 0.5×SSC, 0.1% SDS at 50° C.; and more preferably in 7% SDS, 0.5 M NaPO₄, 1 mM EDTA at 50° C. with washing in 0.1×SSC, 0.1% SDS at 65° C. Suitable computer algorithms to determine substantial similarity between two nucleic acid sequences include, GCS program package (Devereux et al., 1984 Nucl. Acids Res. 12:387), and the BLASTN or FASTA programs (Altschul et al., 1990 Proc. Natl. Acad. Sci. USA. 1990 87:14:5509-13; Altschul et al., J. Mol. Biol. 1990 215:3:403-10; Altschul et al., 1997 Nucleic Acids Res. 25:3389-3402). The default settings provided with these programs are suitable for determining substantial similarity of nucleic acid sequences for purposes of the present invention.

The term “substantially pure” describes a compound, e.g., a protein or polypeptide which has been separated from components which naturally accompany it. Typically, a compound is substantially pure when at least 10%, more preferably at least 20%, more preferably at least 50%, more preferably at least 60%, more preferably at least 75%, more preferably at least 90%, and most preferably at least 99% of the total material (by volume, by wet or dry weight, or by mole percent or mole fraction) in a sample is the compound of interest. Purity can be measured by any appropriate method, e.g., in the case of polypeptides by column chromatography, gel electrophoresis, or HPLC analysis. A compound, e.g., a protein, is also substantially purified when it is essentially free of naturally associated components or when it is separated from the native contaminants which accompany it in its natural state.

Methods useful for carrying out the present invention are described herein or are known in the art.

### EMBODIMENTS

The precise identification of sites of chromosomal translocations, deletions, and insertions will allow us to catalog recurrent gene rearrangements in diseases. This has been the primary impetus for the development of paired end mapping techniques in humans. The basic principle is to identify short sequences from the ends of linear genomic DNA fragments of a specified size. Mapping the paired-end-tag sequences back to the genome allows one to identify PETs that are not explained by the reference genome architecture, thereby identifying sites with chromosomal rearrangements. The sequence information of the aberrant ChromPETs makes it easy to generate PCR primers to amplify and confirm the specific junctional fragment created by the rearrangement. In clinical samples, such disease-specific junctional fragments can be useful molecular markers for the diagnosis of diseases.

Yeast Genome Analysis

The present invention provides compositions and methods based on the evaluation herein of the ability of chromosomal paired-end tag (ChromPET) technique combined with high throughput sequencing to identify sites of chromosomal translocations and large insertions in Saccharomyces cerevisiae, as described in Dutta et al., U.S. Provisional Patent Application No. 61/231,715, filed Aug. 6, 2009. A global approach for identifying and cataloging chromosomal structural variation in lower eukaryotes will facilitate the dissection of how these structural variations arise in the population. To ensure that the yeast had some chromosomal rearrangements that we could use as a test case, we utilized the powerful system developed by Chen and Kolodner to select for gross chromosomal rearrangements (GCRs) in the nonessential portion of chromosome V in haploid cells (3). HXT13 located distal to the CAN1 gene on chromosome V was replaced by the URA3 gene in strain, RDKY3615 (FIG. S1A). CAN1 expression makes cells sensitive to L-canavanine while URA3 expression sensitizes cells to 5-fluorotic acid. Therefore, cells which have inactivated CAN1 and URA3 can be selected on plates containing these drugs and these colonies usually contain deletions of the two genes. It is disclosed herein that the ChromPET technology successfully identifies the junction of chromosomal rearrangement in chromosome V that was responsible for the deletion of CAN1 and URA3. In addition, we identified the disruption of XRS2 with HIS3 insertion and the copying of the HMRa gene into the MAT locus. Of particular interest is the identification of several sites of Ty element insertion not reported in the reference genome sequence, suggesting that the method is useful even for detecting rearrangements involving repeat elements.

For example, a summary of the bioinformatic analysis procedure, based on U.S. provisional patent application No. 61/231,715, from which this application claims priority, and in now published Dutta et al., 2009, Nucleic Acid Res., 37:19:6454, is a follows—

Step 1—Unique ChromPETs

Identify linker sequence in read.

Extract flanking sequences as 5′ and 3′ end of a ChromPET

Identify unique ChromPETs

Step 2—Map ChromPETs

megaBLAST all tags to Yeast Genome

Parse megaBLAST output file to take out address(s) of each ChromPET tag

Step 3—Identify and characterize aberrant ChromPETs

Plot Inter-Tag distances, to identify cutoff that will report on “aberrant” ChromPETs

Apply cutoff to extract “aberrant” ChromPETs

Identify ChromPETs as either normal or a recombination (the two tags map to different chromosomes), insertion (two tags map to within 500 bp of each other) or a deletion (tags maps more than 5 kb away from each other)

For normal ChromPETs, only keep addresses that report on normal genome architecture

Step 4—Generate “Aberrant” ChromPET profile

For each type of ChromPET—normal, insertion, deletion, or recombination—divide address file according to chromosome/tag

For each chromosome, generate wig-formatted profile file

Step 5—Identify dense region

Run a sliding window across chromosomal profile of each class of “aberrant” ChromPET, calculating sum of ChromPET and sum of ChromPET to normal ratio for each window

Identify windows that have high sums of “aberrant” ChromPETs and the ratio (aberrant/normal)

Cutoff determined qualitatively by examining the positive control region

Step 6—Identify aberrant linkages

For each dense region identified, extract all tags that map to that region

For each tag extracted, identify all windows it is linking to with its partner tag, keep a count of how many times a window is hit

Take the window hit the maximum number of times, and check if 75% of extracted ChromPETs hit this window,

If yes, identify the region pair as an “Aberrant Linkage”

Remove all ChromPETs that reported on “Aberrant Linkages” from the population

Recheck for windows that have at least >=8 aberrant ChromPETs that have links to the maximum linkage partner.

Additional descriptions of the yeast results are provided below, based on U.S. provisional patent application No. 61/231,715, from which this application claims priority, and in now published Dutta et al., 2009, Nucleic Acid Res., 37:19:6454

Isolation of Chromosomal Rearrangements on Chromosome V Reporter Region

Yeast cells harboring chromosome V rearrangements were selected on L-canavanine and 5-FOA (3). Breakpoints are expected to localize within the 12.1 kb nonessential region between (or within) CAN1 and the first essential gene PCM1 on the left arm of chromosome V. PCR amplification using primer pairs directed to the essential (5A/5B) and nonessential (5C/5D) regions confirmed loss of the CAN1 locus in our strain RDKY3671GCR.

Next, we constructed the ChromPET (chromosomal paired-end tags) library using RDKY3671GCR genomic DNA that had been fragmented to a size of approximately 1.5-2 kb. Circularization of the fragments by ligation to the T30MmeI adaptor with outwardly directed MmeI sites, followed by digestion with MmeI, released the adaptor along with the adjoining paired-end-tags from each end of the circularized linear fragment. These ChromPETs were then subjected to deep sequencing.

Extraction of Aberrant ChromPETs

The ChromPET library consists of a pair of tags, 16-20 bp long from either end of a genomic DNA fragment, separated by the T30MmeI adaptor. We were able to generate 617,602 reads using the 454 sequencing platform. We mapped the tags back to the yeast genome. We could extract a total of 567,924 ChromPETs (92%) yielding ˜17 megabase of sequence data interrogating the yeast genome (rough genomic coverage of ˜1.5×), 489,479 (86.2%) of these were unique ChromPETs. Of the unique ChromPETs, 380,987 (77.8%) had both ends mapping back to the yeast genome, 84,256 (17.2%) had only one end mapping back to the yeast genome, and 24,236 (5%) had neither of the ends mapping back to the yeast genome.

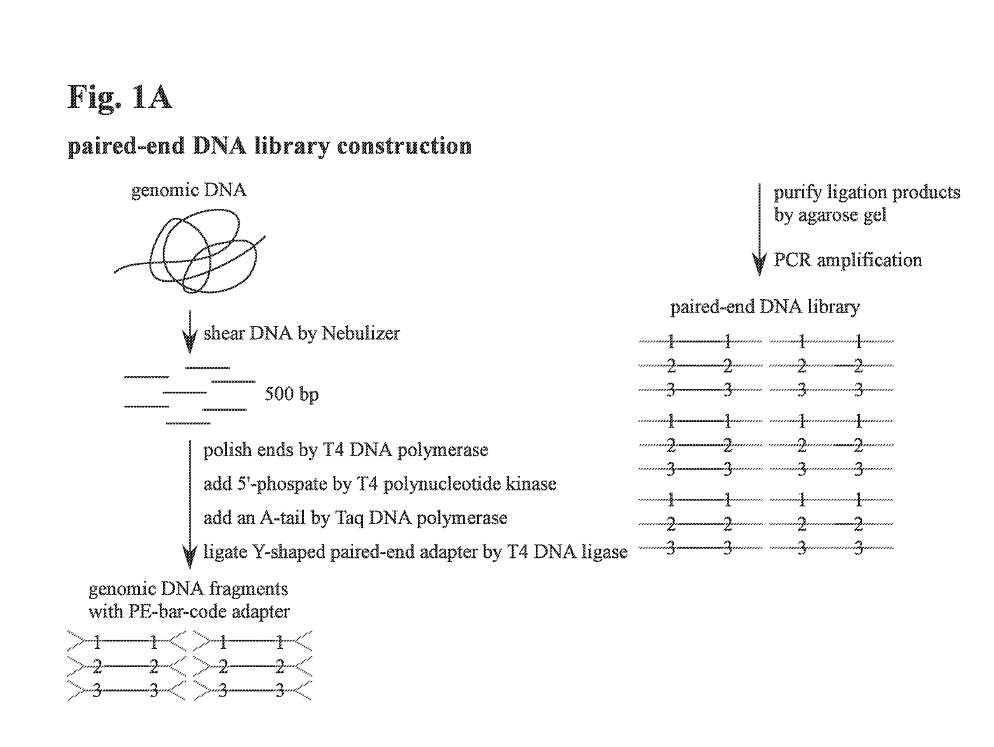

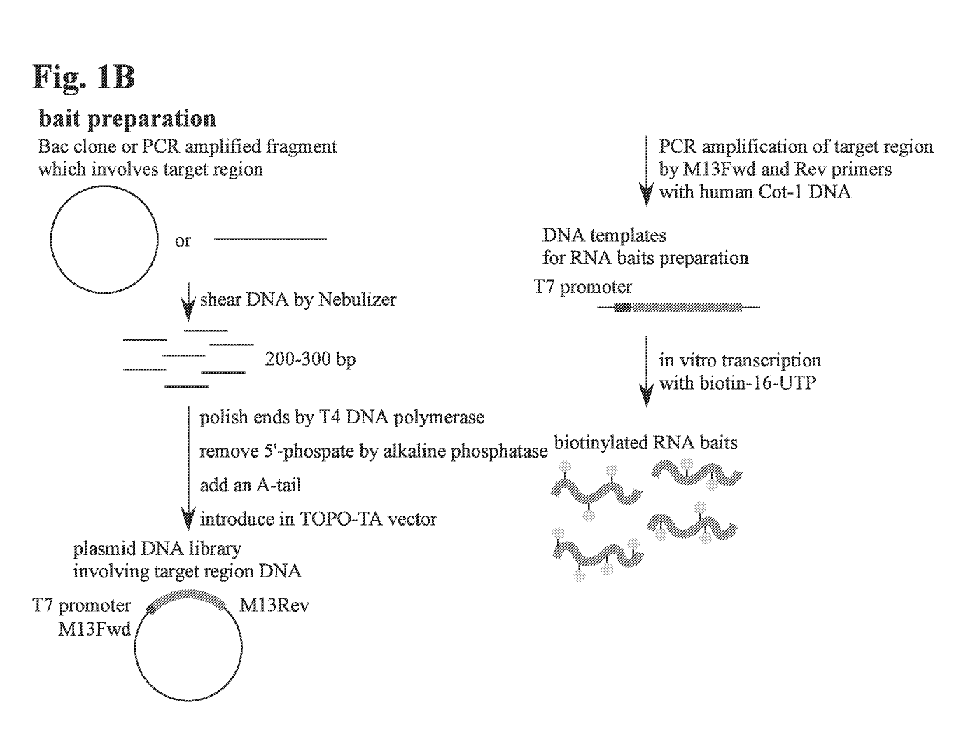

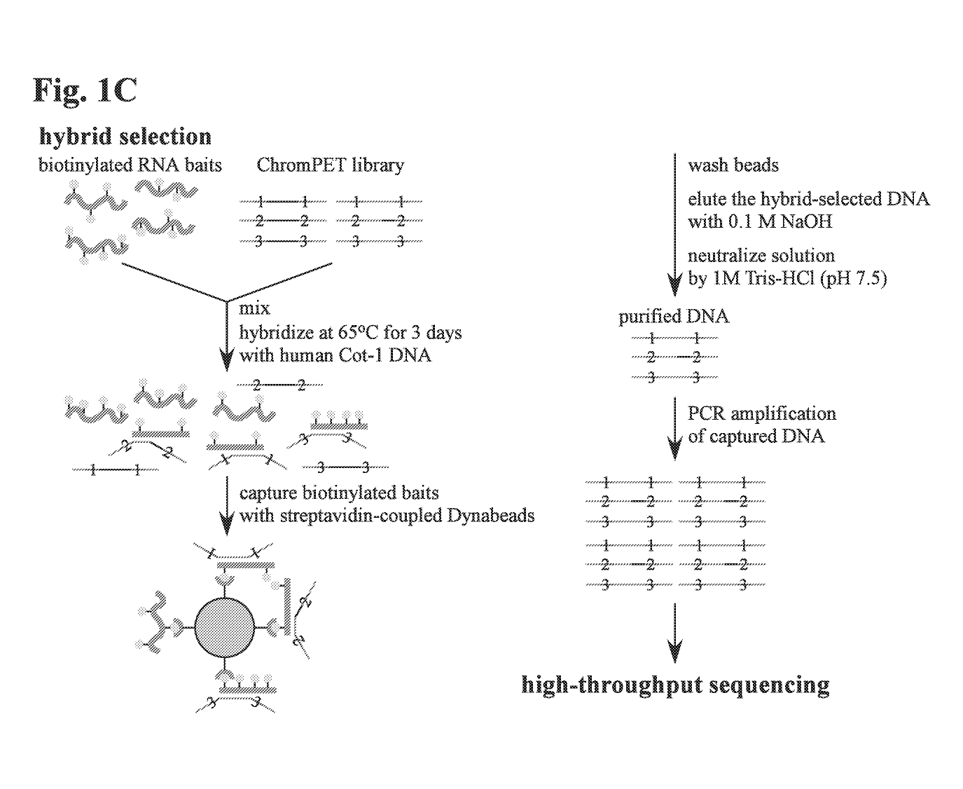

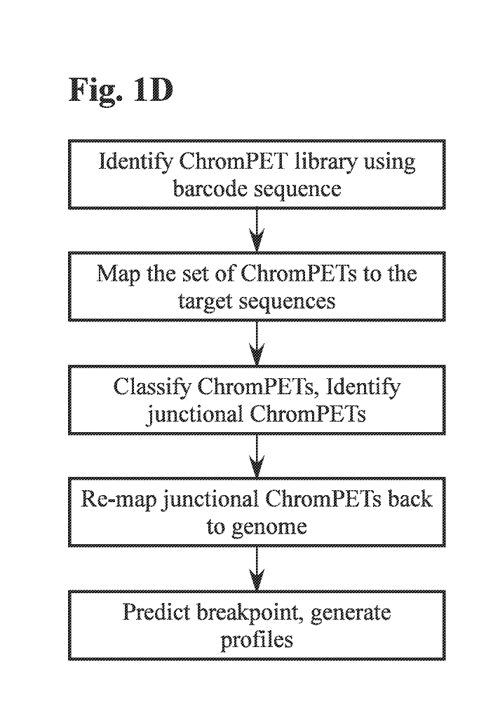

Since the ChromPET library was generated using DNA fragments of approximately 1.5-2 kb in size, any ChromPET whose inter-tag distance was not within this range should be classified as an aberrant ChromPET. Indeed, the distribution of inter-PET distance (FIG. 1B) looks like a Poisson distribution with a mean of ˜1.8 kb and median of 1.15 kb. Inter-PET Distance<=500 bp or >=5000 bp were considered to be reporting on abnormal linkage Almost 92% of the ChromPETs were classified as normal using these bounds. Each of these tags map to multiple sites on the genome. We examine all possible combinations of the mappings of the 5′ and 3′ tag of a ChromPET to further classify the ChromPETs. If one combination reports on a normal linkage 500 bp-5000 bp, the ChromPET is accepted as a normal ChromPET. 19,811 ChromPETs (−5.20%) could not be explained by a normal linkage. The majority of these were reporting on recombinations (14,615-74.54%), but insertions, deletions and ambiguous (data were inconclusive to classify them into any of the other three categories) ChromPETs were also noted.

Exclusion of Chimera Products

Because of our interest in chromosomal translocations, first we analyzed those ChromPETs that suggested abnormal linkage between chromosomes. The analysis pipeline had to address two problems. Because of the short length of the tags and the presence of repeat sequences in the genome, many tags from the abnormal ChromPETs mapped to multiple sites in the genome. In addition, we expected a background level of abnormally mapping ChromPETs from chimera products produced by intermolecular ligation between genomic fragments during library construction. These problems are bypassed, however, by requiring that multiple independent paired-end tags report on an aberrant linkage. To identify such sites, we first calculated the distribution of all ChromPET tags and abnormal ChromPET tags in 2000 bp sliding windows with a slide of 200 bases across the entire genome. The density of abnormal tags (nucleotides covered by abnormal tags) and the density of the abnormal to all tag ratio for one locus were determined and plotted. Sites that had a high density of abnormal tags and abnormal to all tag ratio were flagged as regions dense in abnormal tags and were individually examined. The cut-off in density of abnormal tags was lowered until the CAN1-PCM1 locus scored as being dense in abnormal tags (sum of nucleotides covered by abnormal tags>200 bp/2000 bp; ratio of nucleotides covered by abnormal/all tags>100) and then the cutoffs were lowered by half to obtain a list of windows that have a high density of abnormal tags. This still yielded 12,673 windows for further examination.

For each of these 12,673 window deemed dense in abnormal tags (e.g., W_{—}1), the partner windows reported by each of the abnormal ChromPETs anchored in the W_{—}1 window were tabulated (W 2, W_{—}3 . . . W_{—}6). If >75% of the abnormal ChromPETs anchored in window W_{—}1 linked it to the maximum-linkage partner window, then this linkage was considered to be an abnormal linkage and reported for further consideration. 70 windows with such abnormal linkage coalesced to 10 chromosomal regions with abnormal linkages to be validated by further experiment. Many of the translocations were discovered in both directions.

Since no false positives were detected by this threshold, we decided to relax the threshold further to define abnormal linkages. The distribution of the number of aberrant ChromPETs that reported linkage between a dense window and its maximum-linkage partner locus on the genome was determined. The distribution shows a breakpoint at >=8, which we selected as a new cutoff for selecting further candidates for abnormal linkages. After eliminating the ChromPETs that had already passed the old threshold for an abnormal linkage, we applied this new cutoff. This yielded 61 windows, which then coalesced into 8 regions. We picked one random region from this set for further experiments.

We used the same strategy with the aberrant ChromPETs that were reporting on insertions (the two tags map to the same chromosome but <500 bp apart) and deletions (the two tags map to the same chromosome but >5 kb apart). There were a total of 89 and 26 windows that were dense in these tags respectively. The inter-tag distances for all the ChromPETs reporting insertions were very close to the cutoff of 500 bp, and could be explained by normal genomic fragments. Indeed, PCR of one of the candidate “insertions” for further experimental validation, revealed that it was from a locus that showed normal genomic architecture (data not shown). The existence of normally linked ChomPETs spanning these apparent insertions, confirm our hypothesis.

26 windows reported aberrant linkages suggestive of a deletion, which further coalesced into one region. This turned out to be the yeast mating type locus, with a linkage between the MAT locus and the HMRa locus consistent with the HMRa1 cassette being copied into the MAT locus. Indeed, the yeast strain under study was of mating type a.

Detection of Translocation in Chromosome V Reporter Region

As mentioned above, RDKY3671GCR lacks a nonessential portion of the left arm of chromosome V. Thus, many aberrant tags mapped to this region. The majority of tags that mapped to 33,500-35,000 of chromosome V had paired-tags which mapped to the ribosomal DNA (rDNA) region of chromosome XII. It is hard to map the exact breakpoint in the 100-200 copies of the tandem rDNA repeat at this locus. However, PCR amplification using a unique primer sequence from chromosome V and a primer from the rDNA repeat sequence specifically yielded a product from RDKY3671GCR genomic DNA but not genomic DNA from other strains. In order to avoid the possibility that this was a PCR artifact, we performed a second PCR reaction using the amplified fragment and internal primers. Primer pair 5F/12B successfully amplified DNA fragment with initially amplified DNA as a template. Sequencing this fragment identified the breakpoint. The breakpoint was flanked by microhomology, consistent with previous reports that non-homologous-end-joining using sites of microhomology are responsible for most of the translocations.

Detection of HIS3 Insertion in the XRS2 Coding Region

XRS2 on chromosome IV in RDKY3671 was disrupted by HIS3 insertion and we expected to detect this aberrant linkage in our study. Indeed, many aberrant ChromPETs mapped to the region of chromosome IV (1212600-1219000) where XRS2 is located and to the HIS3 locus located on chromosome XV. As expected, we did not detect any tags that contained XRS2 gene sequence. PCR primers based on the paired tag sequences confirmed the HIS3 insertion in the XRS2 locus.

Detection of Ty Element Insertions in the ura3 Gene and at Several Sites in Chromosome III

Several of the aberrant chromosomal linkages, were anchored on one side at an unique map position but were computationally linked on the other side to multiple sites in the genome. An examination of these other sides revealed that they mapped within Ty elements, raising the possibility that these rearrangements were pointing to Ty element insertions.

The first of these types of anomalous linkages mapped on one side to chromosome V (115400-117000) near the URA3 locus and on the other side to Ty element sequences. The parental strains, RDKY3671 and RDKY3615, carry the mutant ura3-53 allele, which is caused by a Ty element insertion within the coding region of the URA3 gene. PCR amplification across this region of chromosome V from RDKY3671GCR genomic DNA yielded a DNA fragment approximately 6 kb larger than the predicted size fragment obtained using S288C genomic DNA, indicating the presence of a full-length Ty element insertion in the URA3 gene in RDKY3671 derivatives.

ChromPETs were obtained that mapped to chromosome III position 147,000-153,000 and a full length Ty element sequence. As the presence of a Ty element was not reported in the reference genome, we confirmed this structure using PCR. The reference genome predicts that the primer pair 3E/3F would generate a PCR product of 3.8 kb; however, we obtained fragments >10 kb, consistent with the insertion of a full length Ty element. In order to confirm that the PCR product was derived from the correct region, we sequenced both ends of the product. Both ends mapped to the expected sites in the genome, although alignment with the reference sequence showed that the internal region of the PCR amplified fragment was not present in the reference genome and was similar to the Ty element sequence (data not shown).

Aberrant ChromPET linkage was also detected at chromosome III around 83000 with the opposite end linked to a Ty element sequence. This observation was also confirmed by PCR. DNA fragments were amplified with primer pair 3A/T1 which was designed based on tag sequences that mapped to an overlapping region using RDKY3671GCR genomic DNA as a template. Surprisingly, PCR with S288C genomic DNA also yielded similar DNA fragments. These results suggest the presence of Ty element at this locus, even in S288c. In order to confirm this observation further, we designed new primers based on Ty1 sequence and the region upstream of predicted Ty element insertion site. DNA fragments consistent with a Ty element insertion were obtained with these primer pairs. Primer pairs that flanked the predicted insertion site amplified a fragment of 6 kb, consistent with insertion of a full-length Ty1 element. Sequencing confirmed that this insertion has significant homology to a Ty element.

Because the Ty element is missing in the reference sequence obtained from S288c, we wanted to conclusively prove that the Ty element is indeed present in the S288c genome by southern blot analysis of genomic DNA. AseI digestion should yield 2210 bp and 972 bp fragment based on the reference sequence. Instead, we observed a closely migrating doublet) of around 2 kb. In addition, ClaI digestion yielded a 5 kb fragment instead of the expected 3 kb fragment based on the reference sequence. Both of these results are consistent with the sequencing results and indicate the presence of an unannotated Ty element in this region.

Furthermore we found two other ChromPETs that did not correspond to annotated Ty elements on chromosome XII (818200-820400) and again on chromosome III (169800-171900). To confirm these, we designed primers and performed PCR. Primer pairs 3G/T4 and 12C/T5 yielded amplified products, consistent with the insertion of a full length Ty element in these regions.

Anchored ChromPETs for Identifying Chromosomal Translocations in Disease (as Partially Provided in Dutta et al., U.S. Provisional Patent Application No. 61/324,951 filed Apr. 15, 2010)

The present invention encompasses the used of a modification of ChromPET to search for sites of translocation in the genome. Here we describe a modification that will allow us to search for translocation junctions in specific areas of the genome. The method will be useful for molecularly identifying chromosomal breakpoints at sites known to be associated with disease, e.g., the Bcr-Abl translocation in chronic myeloid leukemia, the IgH-Myc translocation in Burkitt's lymphoma, and many other acquired or congenital translocations. The current method to identify the translocations involves the following: the patient's cells have to be cultured in vitro, arrested in metaphase and chromosomal spreads subjected to karyotype analysis by highly trained professionals. The present method disclosed and claimed herein will supplant these processes. The area of interest for anchoring the ChromPETs for diagnostic purposes can be selected based on the Literature (e.g. Bcr-Abl translocation or IgH-Myc)

In one aspect, the area of interest for anchoring the ChromPETs can also be selected de novo by array Comparative Genome Hybridization (Array CGH) of cancer genomic DNA. Array CGH reveals islands of copy number alteration of genomic DNA. The junctions between the islands of amplification or deletion and normal chromosomal DNA can be discerned to a resolution of tens to hundreds of kilobases, a resolution that is not suitable for conversion to PCR based molecular biomarkers. Without wishing to be bound by any particular theory, it is proposed herein that these junctional areas can also be used as areas of interest in our protocol to enrich for ChromPETs anchored in these areas. This modification will allow us to identify patient- and disease-specific aberrant chromosomal linkages at the molecular level at sites that flank the islands of chromosomal copy number variation. All such molecular linkages will yield patient- and disease-specific recombinant molecular biomarkers that can be used for follow up of the disease.

The method is described using as an example the translocation breakpoint expected when RDKY3671GCR strain of S. cerevisiae is grown on 5-FOA and Canavenine. The distal end of chromosome 5 (bearing the URA3 and CAN1 genes are usually deleted in these yeast. Because the PCM1 gene is essential for viability, the breakpoint is in the ˜10 kb interval between the CAN1 and PCM1 genes. Thus, we wish to Anchor ChromPET in this 10 kb interval.

The area of interest (in this case ˜10 kb, but could be as much as a few hundred kb) is purified by specific PCR either from bacmid clones of normal genomic DNA or from the genomic DNA of normal cells. This is then converted into a bait for selection by random PCR to generate approximately 500 bp fragments and tagging of the 5′ or 3′ ends of the DNA with biotinylated nucleotides by standard molecular biology techniques. If the area of interest has repetitive DNA, then the repetitive sequence is eliminated by denaturing the bait and hybridizing to repeat-rich DNA (low CoT DNA) that can be purchased from commercial sources. Double stranded DNA is eliminated by hydroxylapatite chromatography or double strand specific nucleases.

The biotin labeled unique single-stranded sequence from the bait is hybridized to the test genomic DNA that has been fragmented into 0.5-2 kb fragments and denatured. Double stranded DNA is purified on streptavidin agarose beads. The annealed test DNA that is purified on the streptavidin beads is eluted by denaturation and converted to double-stranded DNA by random priming and amplification.

An alternative approach is to have the area of interest represented as millions of single-stranded oligonucleotides (50-60 bases each) anchored to a surface (for example a Nimblegen Chip) and then isolate the area of interest from the patient's genomic sample by hybridizing to the array and elution.

In one embodiment, one method of selection is to attach the trapping DNA to the surface of nano-channels on a nanochip and perform the hybridization and washing in these nano-channels. Elution of the trapped DNA can also be performed from these nano-channels. Thus, a nanochip designed to select specific segments of the genome is a valuable addendum to the Anchored ChromPET technology. Because of the ease of multiplexing such channels on a chip, such a chip is expected to be useful for other high throughput technologies that depend on selecting fragments of the genome for further analysis.

The DNA that has been selected by either of the two strategies described above is then ligated to sequencing adaptors and subjected to paired-end sequencing either directly on a Solexa or Solid machine or converted into paired-end tags as we described earlier and subjected to Roche-454 sequencing.

The computational analysis of the mated paired reads or the paired end tag reads (collectively called ChromPETs) to identify aberrant links has been described earlier. In this manner, we will be able to identify aberrantly linked Anchored ChromPETs (ACP) where one end of the read is anchored in the area of interest and the other end reveals the molecular link to an aberrant chromosomal site. PCR primers based on the aberrant molecular link will be designed and amplification of the junctional fragment from the test DNA will confirm the aberrant link. The PCR primers and the recombinant junction will be a unique biomarker for this patient's disease, which in the case of cancers can be used for molecularly following up the disease for minimal residual disease or for recurrence.

In one embodiment, the present invention encompasses compositions and methods useful for identifying biomarkers characteristic of diseases and disorders. The method comprises obtaining a first sample from a subject with a disease or disorder and analyzing the sample according to the methods of the invention. In addition, the method further comprises obtaining a second otherwise identical sample from an unaffected subject and analyzing the second sample according to the methods of the invention. Then the results of the analysis of the first sample are compared with the results of the analysis of the second sample. A higher or lower level of the indentified marker in the first sample compared to the level of the marker in the otherwise identical sample, is an indication that marker is a biomarker of a disease or disorder. In one aspect, the biomarker is a disease marker for cancer. In one aspect, the cancer is leukemia.

The present invention further provides compositions and methods useful for diagnosing a disease or disorder associated with a biomarker identified by the methods of the invention. The method encompasses obtaining a sample from a test subject, comparing the level of the biomarker of interest in the test subject with the level of the biomarker from an otherwise identical sample from an unaffected subject or from an otherwise identical unaffected sample from said test subject. A higher or lower level of the biomarker in the test subject, compared with the level of the biomarker in the sample from an unaffected subject, or from a standard sample or from an unaffected sample from the test subject, is an indication that the test subject has a disease or disorder associated with the biomarker.

The present invention further provides kits for use in identification of targets as well as for diagnosis to analyze targets identified using the methods of the invention.

The present application discloses a method to identify sites of chromosomal rearrangements by making a library of chromosomal DNA fragments (chromosomal paired end tags or ChromPETs) and subjecting them to ultrahigh throughput sequencing. We have data validating the method on yeast as well as in mammals, which indicate the broad application of this method for DNA from any cell or animal. We believe this method will be useful for identifying sites of chromosomal translocation, gene deletion, and gene insertion in human cancers and can become a genomic diagnostic test that forms the basis of personalized medicine.

The invention further encompasses methods for designing primers that is cancer specific after identifying the translocation in a certain cancer. In the case of CML (or any other leukemia or blood based proliferative disease), you would be able to do PCR on a blood sample, and detect recurrence of that patient's cancer much earlier than you could with microscopic analysis. In the case of bladder cancer, you can do this using, for example, a urine sample, again detecting recurrence much earlier than by protein analysis (not yet available) or endoscopic examination (used today). Therefore, in clinical samples, such disease-specific junctional fragments can be useful molecular markers for the diagnosis of diseases.

Some examples of diseases and disorders which may be identified, diagnosed, or monitored according to the methods of the invention are discussed herein. The invention should not be construed as being limited solely to these examples, as other diseases with chromosomal structural variations which are at present unknown, once known, may also be identified, diagnosed, or monitored using the methods of the invention.

Numerical ranges recited herein by endpoints include all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about.” The term “about” means plus or minus 0.1 to 50%, 5-50%, or 10-40%, preferably 10-20%, more preferably 10% or 15%, of the number to which reference is being made.

In one embodiment, DNA of a target population for analysis is fragmented either randomly or at defined sites. In certain embodiments, the fragmented DNA sample is purified to a predetermined size that defines a spatial window that sets the resolution level for analysis.

One of ordinary skill in the art will appreciate that other techniques known in the art but not described herein can be used to practice the method of the invention. For example, see U.S. Pat. Pub. 20090156431 to Lok, the entirety of which is incorporated by reference herein.

In one embodiment, the present invention provides a kit useful for analyzing DNA according to the methods of the invention. The present invention further provides for diagnostic kits. In one embodiment, the present invention provides a kit useful for diagnosis of cancer. In one aspect, the cancer is CML. For example, contents of the kit include, but are not limited to: a list of reagents for pre-treatment of selected DNA sites for anchoring; Polymerase Chain Reaction reagents; Primer sequences; a list of reagents for Sequencing; instructions and reagents for making the DNA library for paired end tag sequencing; DNA sequence based bar coded to distinguish libraries from different patients; List of materials for Computational platform; Algorithm for searching the ChromPET sequences to identify the translocation junctions spanning BCR-ABL and ABL-BCR; Primers to PCR amplify the translocation junction and sequence the junctional fragments for confirmation; and an instructional material for the use thereof.

The invention is now described with reference to the following Examples. Without further description, it is believed that one of ordinary skill in the art can, using the preceding description and the following illustrative examples, make and utilize the present invention and practice the methods of the invention. The following working examples therefore, are provided for the purpose of illustration only and specifically point out the preferred embodiments of the present invention, and are not to be construed as limiting in any way the remainder of the disclosure. Therefore, the examples should be construed to encompass any and all variations which become evident as a result of the teaching provided herein.

### EXAMPLES

### Methods

### Reagents

APex Heat-Labile Alkaline Phosphatase: Epicentre (AP49010), Biotin-16-UTP: Roche (11388908910), DNAZo1 reagent: Invitrogen (10503-027), Dynabeads M-280 streptavidin: Invitorgen (112-05D), End-It DNA end repair kit: Epicentre (ER0720), human Cot-1 DNA: Invitrogen (15279-011), MAXlscript Kit: Ambion (AM1312), MinElute Reaction Cleanup Kit: Qiagen (28204), pCR4-TOPO-TA vector: Invitrogen (K4575-01), QIAquick Gel Extraction Kit: Qiagen (28704), QIAquick PCR purification kit: Qiagen (28104), QuickExtract FFPE DNA Extraction Kit: Epicentre (QEF81805), QuickExtract FFPE RNA Extraction Kit: Epicentre (QFR82805), Quick Ligation Kit: NEB (M2200S), SuperScript III Reverse Transcriptase: Invitrogen (18080-093), TaKaRa Ex Taq DNA Polymerase: Takara (TAK RR001A), Taq DNA polymerase: Roche (11146165001), TRIzol: Invitrogen (15596-026), TURBO DNase: Ambion (AM2238) were used.

Cell Lines

K562 cells (CCL-243) and KU812 cells (CRL-2099) were purchased from ATCC and cultured according to ATCC instructions.

Patient Samples

Genomic DNA from peripheral blood mononuclear cells were kindly provided by Dr. Brian Druker (Oregon Health and Science University). Ph+ or Ph− patient samples were obtained with informed consent and under the approval of the Oregon Health and Science University Institutional Review Board. Mononuclear cells were isolated by separation on a Ficoll gradient (GE Healthcare), followed by purification of genomic DNA using the Dneasy Blood and Tissue kit (Qiagen).

PCR Primers

PCR primers used for this study are listed in Table 51.

ChromPET Library Construction

All ChromPET libraries were constructed according to the protocol supplied by Illumina with minor modifications. Genomic DNA was extracted with DNAZo1 reagent and 2 μg of DNA was sheared by a Nebulizer for 5 min by compressed air at 32-35 psi. After purifying the sample with QIAquick PCR purification kit, fragmented DNA was run in 2.0% agarose gel, 0.5 kb fragments were excised from the gel and extracted with QIAquick Gel Extraction Kit. The ends of DNA fragments were polished by End-It DNA end repair kit and A-tail added to the 3′ end by 0.25 unit of Taq DNA polymerase. The Y-shaped adapter containing the bar code was ligated to both ends of DNA fragments by Quick Ligation Kit and purified again by 2.0% agarose gel electrophoresis and QIAquick Gel Extraction Kit. Y-shaped adapter ligated DNA was amplified by PCR primer PE1.0 and 2.0 for 15 cycles and the amplified fragment was again purified by 2.0% agarose gel electrophoresis and QIAquick Gel Extraction Kit. The sequences of adapters and primers are shown in Supplemental Table 51.

RNA Bait Preparation

6.6 kb DNA containing the M-Bcr region was amplified from normal lung genomic DNA using PCR primer pair M-BCR—F1 and R1. 2 μg of amplified DNA was sheared in a Nebulizer for 8 min by compressed air at 32-35 psi to obtain 0.3 kb fragments, overhanging ends blunted by 2 units of T4 DNA polymerase, 5′ end dephosphorylated by 1 μl of APex Heat-Labile Alkaline Phosphatase, and A base overhang added to the 3′ end by 0.25 units of Taq DNA polymerase. Following each step, the sample was cleaned up by MinElute Reaction Cleanup Kit. The DNA was cloned into the pCR4-TOPO-TA vector and the resulting construct used to transform E. coli competent cells (TOP10). Plasmid DNA was purified from pooled colonies and inserts were amplified by PCR (M13 forward and reverse primer). A 100 μA reaction volume was prepared using 10 ng plasmid DNA, 10 μl 10X Ex Taq Buffer (contains 20 mM MgCl₂), 2.4 μl 25 mM dNTP solution, 0.6 μl of 100 μM M13 forward and reverse primer sets, 5 U TaKaRa Ex Taq DNA Polymerase and distilled, deionized H₂O. 100 ng of repeat-rich DNA (human Cot-1 DNA) was also included in the reaction mixture to eliminate repetitive sequences by interfering with extension of the probe across repetitive sequences. [19]. The temperature-time cycling profile was as follows; 95° C. for 5 min followed by 20 cycles of 94° C. for 1 min, 55° C. for 20 sec and 72° C. for 30 sec. This was followed by 5 min at 72° C. and a hold at 4° C. until tubes were removed. The DNA was then converted into RNA bait for selection by in vitro transcription reaction with Biotin-16-UTP (MAXIscript Kit), following which, the DNA template was eliminated by TURBO DNase.

Anchored ChromPET Library Preparation

500 ng of biotin-labeled unique single-stranded RNA from the bait was hybridized to 500 ng of heat-denatured ChromPET library in a 26 μl of hybridization mixture (5×SSPE, 5×Denhardt's′, 5 mM EDTA, 0.1% SDS, 20 U SUPERase-In) including 2.5 μg of heat-denatured human Cot-1 DNA and salmon sperm DNA at 65° C. for 3 days. RNA-DNA hybrid was captured on Dynabeads M-280 streptavidin that had been washed 3 times and resuspended in 200 ul of 1M NaCl, 10 mM Tris-HCl (pH 7.5), 1 mM EDTA and 100 μg/ml salmon sperm DNA. RNA-DNA hybrid capture beads were washed with 0.5 ml of 1×SSC/0.1% SDS once for 15 mM at 20° C. and then with 0.5 ml of 0.1×SSC/0.1% SDS for 15 min at 65° C. three times. The annealed DNA was eluted by 50 μl of 0.1M NaOH, neutralized by 70 μl of 1M tris-HCl(pH7.5) and converted to double-stranded DNA by paired-end PCR primer PE1.0 and 2.0. DNA fragment was purified by 2.0% agarose gel electrophoresis and high-throughput sequencing was performed according to the manufacturer's protocol (Illumina).

Bioinformatics Pipeline

To identify the sample for each individual ChromPET in the multiplexed sequencing runs, we used a 4 bp bar code that was included in the sample-specific Y-primers and was appended to the 5′ end of each sequence. Allowing 1 bp mismatch (only in degenerate positions) the ChromPET was assigned to one of the samples or left unassigned. The 38-bp paired end tag reads obtained from the sequencer were mapped to the targeted regions using Novocraft Novoalign program (Ver. 2.05; see the Novocraft website) extracted the sequence of the mBCR locus and the sequence of the ABL1 gene and indexed them using Novoindex program (a part of the NovoAlign package). The mapping was done using default mapping parameters (novoalign-r All-e 50). We then used the pipeline as described in (1), to identify ChromPETs that have both tags mapping back uniquely to the target regions. The ChromPETs were then classified into normal ChromPETs (mapping BCR-BCR and ABL1-ABL1) and junctional ChromPETs (BCR-ABL1 or ABL1-BCR).

Algorithm for Breakpoint Prediction

The algorithm for breakpoint detection is based on a voting procedure. We allow each junctional ChromPET to vote on the location of the actual breakpoint (FIG. S2). First, the normal ChromPETs for all samples is used to estimate the average and standard deviation of fragment lengths. Using these estimates, each tag of a junctional ChromPET votes on the likely location of the breakpoint: vote of 3 to the interval that is the average fragment length downstream from the start of the tag, vote of 2 to the interval one standard deviation down from the end of the 3 zone, and vote of 1 to the interval another standard deviation downstream from the 2 zone. All votes are totaled and plotted over the BCR (or ABL) locus, and the region with the maximum votes contains the predicted breakpoint. The DNA primers to amplify the junctional fragment (for sequencing across the junction) are designed to encompass this predicted breakpoint-containing region.

DNA and RNA Extraction

DNA and RNA from freshly prepared cell lines, formalin fixed cells, and culture medium were extracted with DNAzol, Trizol, QuickExtract FFPE DNA Extraction Kit, or QuickExtract FFPE RNA Extraction Kit according to the manufacturer's protocol.

Results:

Effective Capture of the Target Regions and Sample Multiplexing

The ChromPET library was constructed according to the manufacturer's protocol with a slight modification. We used Y-shaped adapters that encoded bar code sequence immediately after the sequencing primer and before the insert to be sequenced (FIG. 1A). Approximately 6.6 kb including the M-bcr region was obtained by PCR from normal lung genomic DNA and converted into a biotinylated RNA bait as described in the methods (FIG. 1B). The ChromPET library was then hybridized to the RNA bait and purified on streptavidin beads (FIG. 1C). We verified that the selection method successfully enriched DNA annealing to the M-bcr region by quantitative real time PCR using primers (M-BCR-F2 and R2) mapping to 5′ region of M-bcr. The patient samples showed 5,800 to 17,000 fold enrichment of BCR DNA by the selection procedure (FIG. S1).

Identification of Junctional ChromPETs

We multiplexed the bar coded libraries from two leukemia cell lines, K562 and KU812 into one lane and that from three patient samples, PS1, PS2, and PS3 into another lane of the Illumina Genome Analyzer. Thirty-eight (38) cycles of paired end sequencing were performed using the protocols provided by the manufacturer.

As shown in Table 1, we sequenced 3.2 million 38 bp paired end reads from the lane with cell lines and approximately 0.5 million 38 bp paired end reads from the lane with patient samples. The sequenced reads obtained from the Illumina Genome Analyser were processed through the bioinformatics pipeline as shown in FIG. 1D (described in Materials and Methods). The resulting ChromPETs from the pipeline are classified into two categories: 1) ChromPETs that map normally to the BCR or the ABL region and 2) Junctional ChromPETs that map across the junction between BCR and ABL1.

Using the criteria on identification of bar codes described in the Methods, the percentage of ChromPETs assigned to each sample was ˜5% for the K562 cell line and ˜45% for the KU812 cell line. For the patient samples, the percentages were 15%, 45%, and 6% for PS1, 2 and 3, respectively. The numbers point to a low efficiency of bar coding for two of the samples (K562 and PS3), and more study is needed for the choice of uniformly efficient bar codes.

Using default mapping parameters (described in Methods) we obtained a large but variable number of ChromPETs (Table 1) anchored in the BCR locus (21,798-403 ChromPETs). However, the variable number of sequences mapping to the BCR region allowed us to empirically demonstrate how few sequences were required to use Anchored ChromPET to identify the chromosomal translocation breakpoints. Of the BCR-Anchored ChromPETs, 2-4.6% were junctional ChromPETs that mapped between the BCR and ABL locus.

We next devised an algorithm that utilizes the mapping coordinates of each end of a junctional ChromPET together with the distribution of sizes of normal ChromPETs to predict the most likely position for the breakpoint between the BCR and ABL1 loci (FIG. S2 and Methods).

FIG. S3 shows the profile of breakpoint predictions over the M-bcr and ABL1 loci for each sample. For the two cell lines and patient samples 1 and 2, we have well defined peaks in the breakpoint profile in both the M-bcr and ABL1 loci. The locations of these peaks are considered the predicted breakpoints. In contrast, for patient sample 3 the breakpoint predictions are dispersed and do not yield a single peak. The genome coordinates of the predicted breakpoints are shown in Table 2.

### Table 1 (Comprising Tables 1A and 1B). Number of ChromPETs Sequenced, Mapped, Anchored to BCR and Junctional for Each Sample (A) Cell Lines and (B) Patient Samples

TABLE 1A
Sequencing and Mapping numbers for Cell Lines

| Total Reads | 3249760 | | | |
|---|---|---|---|---|
| Cell Line | K562 | | KU812 | |
| Bar Coded Reads | 161,365 | | 1,468,876 | |
| Tag | 1st | 2nd | 1st | 2nd |
| Mapped | 24385 | 25310 | 243684 | 246861 |
| Percent Mapped | 15 | 16 | 17 | 17 |
| Mapped Uniquely | 12800 | 13321 | 125795 | 122665 |

| | | |
|---|---|---|
| Total Anchored | 2839 | 21798 |
| ChromPETs | | |
| Junctional ChromPETs | 131 | 427 |
| Percent Breakpoint | 4.6 | 2.0 |

TABLE 1B
Sequencing and Mapping numbers for Patient Samples
Total Reads 592,785

| | Cell Line | | | | | |
|---|---|---|---|---|---|---|
| | Sample 1 | | Sample 2 | | Sample 3 | |
| | Bar Coded Reads | | | | | |
| | 89316 | | 258239 | | 37538 | |
| | Tag | | | | | |
| | 1st | 2nd | 1st | 2nd | 1st | 2nd |
| Mapped | 8952 | 8861 | 30586 | 32275 | 3782 | 3966 |
| Percent | 10.0 | 9.9 | 11.8 | 12.5 | 10.1 | 10.6 |
| Mapped | | | | | | |
| Mapped | 4824 | 4828 | 16456 | 17248 | 2186 | 2232 |
| Uniquely | | | | | | |

| | | | |
|---|---|---|---|
| Total Anchored | 994 | 3753 | 403 |
| ChromPETs | | | |
| Junctional | 23 | 92 | 10 |
| ChromPETs | | | |
| Percent | 2.3 | 2.5 | 2.5 |
| Breakpoint | | | |

Table 2 (comprising Table 2A and 2B). Predicted And Actual Breakpoints For Each Sample:

TABLE 2A
Predicted breakpoints from each sample

Prediction

| Sample | M-BCR | ABL1 |
|---|---|---|
| K562 | 110,194-110,207 | 27,762-27,909 |
| KU812 | 110,241-110,242 | 63,843-63,853 |
| Patient 1 | 109,790-109,830 | 125,280-125,623 |
| Patient 2 | 109,702-109,867 | 102,484-102,653 |

TABLE 2B
Actual breakpoints from each sample

| | | Actual | | Difference (bp) | |
|---|---|---|---|---|---|
| Sample | Break Point | M-BCR | ABL1 | M-BCR | ABL1 |
| K562 | BCR-ABL1 | 110,191- | 27,878- | 3 | 0 |
| | | 110,192 | 27,879 | | |
| KU812 | BCR-ABL1 | 110,299- | 63,929- | 57 | 76 |
| | | 110,300 | 63,930 | | |
| | ABL1-BCR | 110,096- | 63,804- | 144 | 38 |
| | | 110,097 | 63,805 | | |
| Patient 1 | BCR-ABL1 | 109,781- | 125,326- | 8 | 0 |
| | | 109,782 | 125,327 | | |
| | ABL1-BCR | 109,670- | 149,445- | 119 | ^{#}23822 |
| | | 109,671 | 149,446 | | |
| Patient 2 | BCR-ABL1 | 109,834- | 102,524- | 0 | 0 |
| | | 109,835 | 102,525 | | |
| | ABL1-BCR | 109,869- | 102,526- | 2 | 0 |
| | | 109,870 | 102,527 | | |

All M-BCR coordinates are relative to chr22: 23,522,552 (Start position of BCR gene) All ABL1 coordinates are relative to chr9: 133,586,268 (Start position of ABL1 gene)
^{#}We had a secondary peak at this locus in Patient 1 ABL1 breakpoint profile - Suppl. FIG. 1D.

In Table 2, the absolute difference (in bp) between predicted breakpoint site and sequenced breakpoint site is shown in the last two columns.

TABLE S1
PCR primers and adapters used

| | | SEQ |
|---|---|---|
| Primer Name | Sequence | ID NO |
| M13 Forward | GTAAAACGACGGCCAG | 1 |
| M13 Reverse | CAGGAAACAGCTATGAC | 2 |
| M-BCR-F1 | CAGGCCCTTTCCAGATTCCACACCT | 3 |
| M-BCR-R1 | CCCCAAGGGAGAAGGGAAGTCCAGT | 4 |
| M-BCR-F2 | CCCAGGGTTTCCTGTCATAACATAG | 5 |
| M-BCR-R2 | GTGAGGAAAAGGGGCTTATTTCTG | 6 |
| K562DF1 | TCCACTCAGCCACTGGATTTAAGCA | 7 |
| K562DR1 | GGTGAATTGGAAAGAAGCAGCAGGT | 8 |
| K562DF3 | AAACAGGGAGGTTGTTCAGATGAC | 9 |
| K562DR3 | AAGGGTATTTCTGTTTGGGTATGGA | 10 |
| KU812DF1 | GAATGTCATCGTCCACTCAGCCACT | 11 |
| KU812DR1 | TTGTTGTGCAGAATTCCCACCAGTC | 12 |
| KU812DF3 | CCTTCTGGGTGTGGAATTGT | 13 |
| KU812DR3 | TCACTTTCTTCTGCATGAAACTTTA | 14 |
| PhS1F9 | ATGGGACTAGTGGACTTTGG | 15 |
| PhS1R9 | GTCTTTACTACAAATACAAAAATCA | 16 |
| | GC | |
| PhS1F2.2 | TGCCTTCAAAGTTCATTTGGGAAAA | 17 |
| PhS1R2.2 | AGTGGCTGAGTGGACGATGACATTC | 18 |
| PhS2F1.2 | CAAGCTGTTTTGCATTCACTGTTGC | 19 |
| PhS2R1.2 | GTCTTGAACTTCTGGGGCTCAAGTG | 20 |
| PhS2F2.2 | TTCAACCCACAAGGAGCTCACAGTC | 21 |
| PhS2R2.2 | AAGGCATCAACCAGCACAAACACTC | 22 |
| BCRe13F1 | AGCATTCCGCTGACCATCAATAAGG | 23 |
| ABL1a2R1 | GGCCACAAAATCATACAGTGCAACG | 24 |
| hPCNA-F1 | GTGGTCGTTGTCTTTCTAGGTCTCA | 25 |
| hPCNA-R1 | GGAAGGAGGAAAGTCTAGCTGGTTT | 26 |
| PCR primer PE | AATGATACGGCGACCACCGAGATCT | 27 |
| 1.0 | ACACTCTTTCCCTACACGACGCTCT | |
| | TCCGATCT | |
| PCR primer PE | CAAGCAGAAGACGGCATACGAGAT | 28 |
| 2.0 | CGGTCTCGGCATTCCTGCTGAACCG | |
| | CTCTTCCGATCT | |
| PEadapters2 | 5′p- | 29 |
| | TCGAGATCGGAAGAGCGGTTCAGC | |
| | AGGAATGCCGAG 3′ | 30 |
| | 3′ TAGCTCTAGCCTTCTCGCAGCA | |
| | CATCCCTTTCTCACA 5′ | |
| PEadapters3 | 5′p- | 31 |
| | GCTAGATCGGAAGAGCGGTTCAGC | |
| | AGGAATGCCGAG 3′ | 32 |
| | 3′ TCGATCTAGCCTTCTCGCAGCA | |
| | CATCCCTTTCTCACA 5′ | |
| PEadapters4 | 5′p- | 33 |
| | ACCAGATCGGAAGAGCGGTTCAGC | |
| | AGGAATGCCGAG 3′ | 34 |
| | 3′ TTGGTCTAGCCTTCTCGCAGCA | |
| | CATCCCTTTCTCACA 5′ | |

The right column of Table S1 indicates the sequence identification numbers (SEQ ID NO) of each sequence.

Other sequences of the invention are provided in the figures and include:

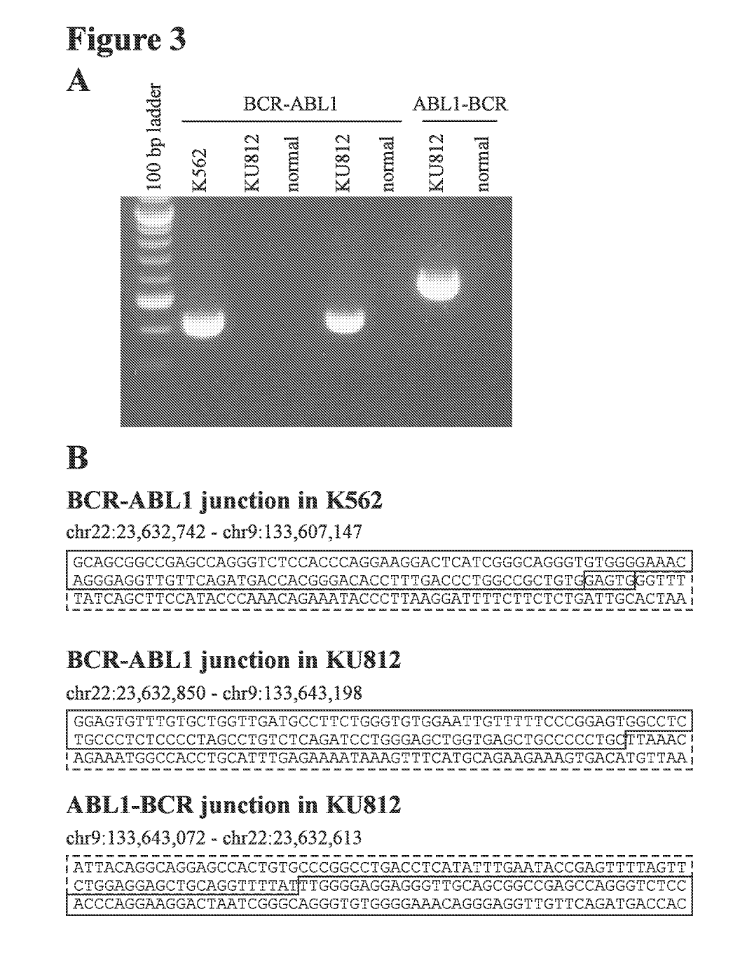

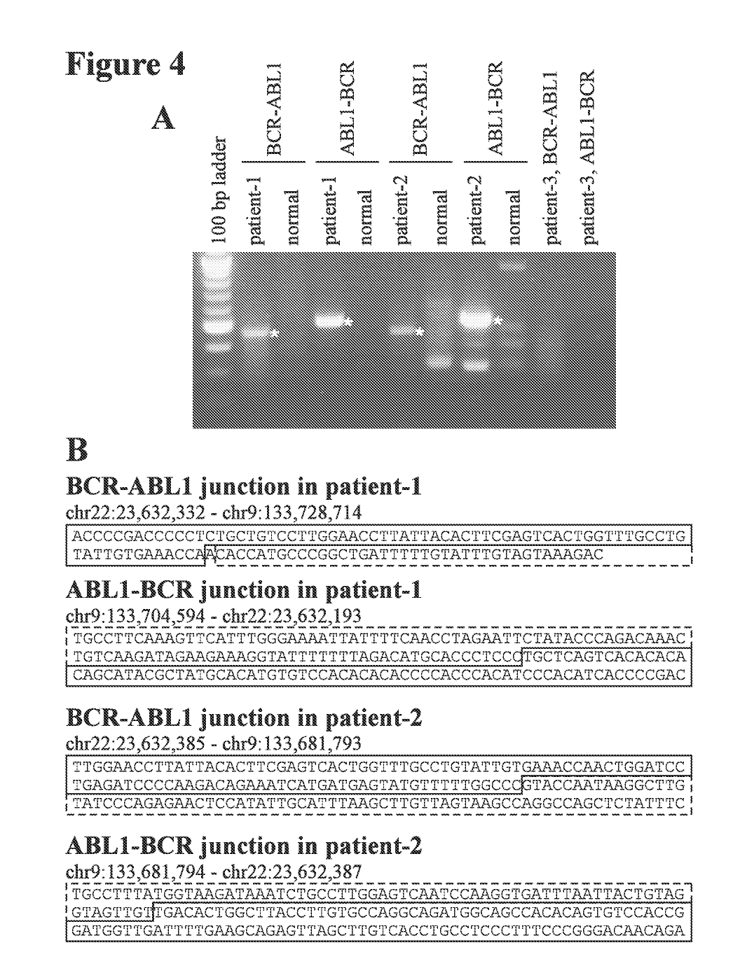

Figure 3B-
BCR-ABL1 junction in K562- chr22: 23,632,742 - chr9: 133,607,147
SEQ ID NO.: 35-
GCAGCGGCCGAGCCAGGGTCTCCACCCAGGAAGGACTCATCGGGCAGGGTG
TGGGGAAACAGGGAGGTTGTTCAGATGACCACGGGACACCTTTGACCCTGG
CCGCTGTGGAGTGGGTTTTATCAGCTTCCATACCCAAACAGAAATACCCTTA
AGGATTTTCTTCTCTGATTGCACTAA
BCR-ABL1 junction in KU812- chr22: 23,632,850 - chr9: 133,643,198
SEQ ID NO.: 36-
GGAGTGTTTGTGCTGGTTGATGCCTTCTGGGTGTGGAATTGTTTTTCCCGGA
GTGGCCTCTGCCCTCTCCCCTAGCCTGTCTCAGATCCTGGGAGCTGGTGAGC
TGCCCCCTGCTTAAACAGAAATGGCCACCTGCATTTGAGAAAATAAAGTTTC
ATGCAGAAGAAAGTGACATGTTAA
ABL1-BCR junction in KU812- chr9: 133,643,072 - chr22: 23,632,613
SEQ ID NO.: 37-
ATTACAGGCAGGAGCCACTGTGCCCGGCCTGACCTCATATTTGAATACCGA
GTTTTAGTTCTGGAGGAGCTGCAGGTTTTATTTGGGGAGGAGGGTTGCAGCG
GCCGAGCCAGGGTCTCCACCCAGGAAGGACTAATCGGGCAGGGTGTGGGG
AAACAGGGAGGTTGTTCAGATGACCAC.
Figure 4B
BCR-ABL1 junction in patient-1- chr22: 23,632,332 - chr9: 133,728,714
SEQ ID NO.: 38-
ACCCCGACCCCCTCTGCTGTCCTTGGAACCTTATTACACTTCGAGTCACTGG
TTTGCCTGTATTGTGAAACCAACACCATGCCCGGCTGATTTTTGTATTTGTA
GTAAAGAC
ABL1 -B CR junction in patient-1- chr9: 133,704,594 - chr22: 23,632,193
SEQ ID NO.: 39-
TGCCTTCAAAGTTCATTTGGGAAAATTATTTTCAACCTAGAATTCTATACCC
AGACAAACTGTCAAGATAGAAGAAAGGTATTTTTTTAGACATGCACCCTCC
CTGCTCAGTCACACACACAGCATACGCTATGCACATGTGTCCACACACACCC
CACCCACATCCCACATCACCCCGAC
BCR-ABL1 junction in patient-2- chr22: 23,632,385 - chr9: 133,681,793
SEQ ID NO.: 40-
TTGGAACCTTATTACACTTCGAGTCACTGGTTTGCCTGTATTGTGAAACCAA
CTGGATCCTGAGATCCCCAAGACAGAAATCATGATGAGTATGTTTTTGGCCC
GTACCAATAAGGCTTGTATCCCAGAGAACTCCATATTGCATTTAAGCTTGTT
AGTAAGCCAGGCCAGCTCTATTTC
ABL1-BCR junction in patient-2- chr9: 133,681,794 - chr22: 23,632,387
SEQ ID NO.: 41-
TGCCTTTATGGTAAGATAAATCTGCCTTGGAGTCAATCCAAGGTGATTTAAT
TACTGTAGGTAGTTGTTGACACTGGCTTACCTTGTGCCAGGCAGATGGCAGC
CACACAGTGTCCACCGGATGGTTGATTTTGAAGCAGAGTTAGCTTGTCACCT
GCCTCCCTTTCCCGGGACAACAGA
Figure S5A
3′ end of BCR in BCR-ABL1 fusion: chr22: 23,632,350-23,632,850
SEQ ID NO.: 42-
CCAAGACAGAAATCATGATGAGTATGTTTTTGGCCCATGACACTGGCTTACC
TTGTGCCAGGCAGATGGCAGCCACACAGTGTCCACCGGATGGTTGATTTTG
AAGCAGAGTTAGCTTGTCACCTGCCTCCCTTTCCCGGGACAACAGAAGCTG
ACCTCTTTGATCTCTTGCGCAGATGATGAGTCTCCGGGGCTCTATGGGTTTC
TGAATGTCATCGTCCACTCAGCCACTGGATTTAAGCAGAGTTCAAGTAAGTA
CTGGTTTGGGGAGGAGGGTTGCAGCGGCCGAGCCAGGGTCTCCACCCAGGA
AGGACTCATCGGGCAGGGTGTGGGGAAACAGGGAGGTTGTTCAGATGACCA
CGGGACACCTTTGACCCTGGCCGCTGTGGAGTGTTTGTGCTGGTTGATGCCT
TCTGGGTGTGGAATTGTTTTTCCCGGAGTGGCCTCTGCCCTCTCCCCTAGCCT
GTCTCAGATCCTGGGAGCTGGTGAGCTGCCCCCTGC
5′ end of BCR in ABL1-BCR fusion: chr22: 23,632,613-23,633,084
SEQ ID NO.: 43-
TTGGGGAGGAGGGTTGCAGCGGCCGAGCCAGGGTCTCCACCCAGGAAGGA
CTCATCGGGCAGGGTGTGGGGAAACAGGGAGGTTGTTCAGATGACCACGGG
ACACCTTTGACCCTGGCCGCTGTGGAGTGTTTGTGCTGGTTGATGCCTTCTG
GGTGTGGAATTGTTTTTCCCGGAGTGGCCTCTGCCCTCTCCCCTAGCCTGTCT
CAGATCCTGGGAGCTGGTGAGCTGCCCCCTGCAGGTGGATCGAGTAATTGC
AGGGGTTTGGCAAGGACTTTGACAGACATCCCCAGGGGTGCCCGGGAGTGT
GGGGTCCAAGCCAGGAGGGCTGTCAGCAGTGCACCTTCACCCCACAGCAGA
GCAGATTTGGCTGCTCTGTCGAGCTGGATGGATACTACTTTTTTTTTCCTTTC
CCTCTAAGTGGGGGTCTCCCCCAGCTACTGGAGCTGTCAGAACAGTGAAGG
CTGGTAACA.

Prediction and Validation of Translocation Breakpoints in CML Cell Lines

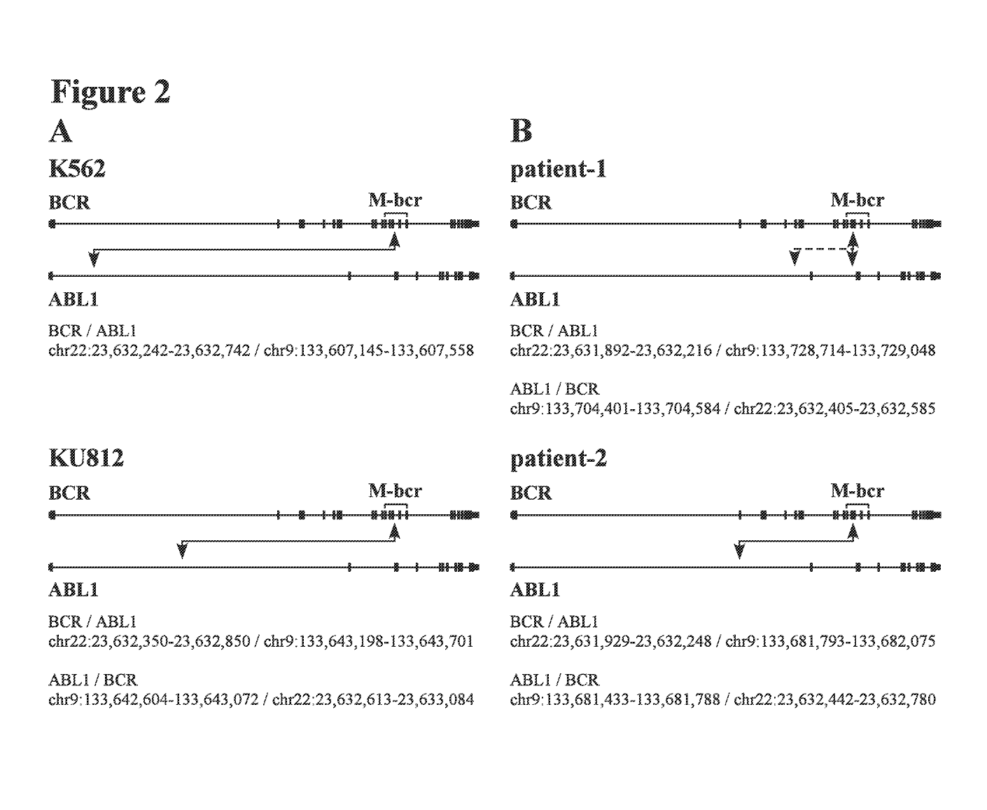

The bioinformatics prediction of breakpoints in K562 cells (Table 2 and FIG. 2A) agreed well with the breakpoint reported in the Literature [20]. To reconfirm this breakpoint, we designed primers flanking these sites and could amplify the junctional fragment from K562 genomic DNA but not from normal lung genomic DNA (FIG. 3A). The sequence of the amplified product (FIG. 3B) confirmed the reported breakpoint and our bioinformatics prediction.

In a similar fashion, we predicted the BCR-ABL1 junction in KU812 cells (FIG. 2A) and confirmed the prediction by amplifying the junctional fragment and sequencing (FIG. 3B). Again, our predicted and observed breakpoint agreed with that reported in the Literature [20]. We also identified the ABL1-BCR reciprocal translocation in KU812 cells: sequence tags mapped to chr9:133,642,604-133,643,072 in ABL1 gene were linked to chr22:23,632,613-23,633,084 in M-bcr (FIG. 2A). Again, the predicted ABL1-BCR junction was confirmed experimentally and found to match exactly with the observed junction (FIG. 3B). These data suggest that Anchored ChromPET is capable of identifying gene rearrangements in a targeted region of the genome.

Prediction and Validation of Translocation Breakpoints in Patient Samples

We next examined the ability of Anchored ChromPET to identify aberrant translocations in patient samples. To this end, we tested this approach on DNA from blasts in blood samples from Ph(+) patient-1 and 2. As a negative control, we also tested this technique in Ph(−) patient-3. The predicted breakpoints for PS1 and PS2 are reported in Table 2 and FIG. 2B.

Based on these results, we designed primer sets, amplified the junctional fragments and confirmed the BCR-ABL1 and ABL1-BCR translocations in both these patients. As shown in FIG. 4A, predicted junctional fragments were reproducibly amplified from the genomic DNA of patients' blast cells but not from normal lung genomic DNA. Sequencing data of amplified fragments clearly showed the BCR-ABL1 or ABL1-BCR junctions in each of these patients (FIG. 4B).

A few M-bcr Anchored ChromPETs were also linked to the ABL1 locus in patient-3, but the predicted breakpoints were dispersed and a unique breakpoint was not predicted using our algorithm. Indeed, PCR with primers spanning the sites that had even the minor peaks (FIG. S3 C, D) did not amplify and junctional fragments from the blast cells from patient-3. This suggests that the junctional ChromPETs detected were probably due to contamination with PS1 or PS2 DNA during Anchored ChromPET library construction. A retrospective analysis of our protocol indicates that two dispensable steps, both involving gel electrophoresis for size-selecting the ChromPET library, are the most likely source for this contamination because all three patient libraries were processed simultaneously on the same gel. Of course, we cannot completely exclude the possibility of an atypical BCR-ABL translocation in patient-3 because the region we have tested is only the 6.6 kb M-bcr area. In the future, we will expand our anchored area to include the entire BCR gene to definitively eliminate the possibility of a BCR-ABL translocation.

Comparison of Sensitivity, DNA or RNA

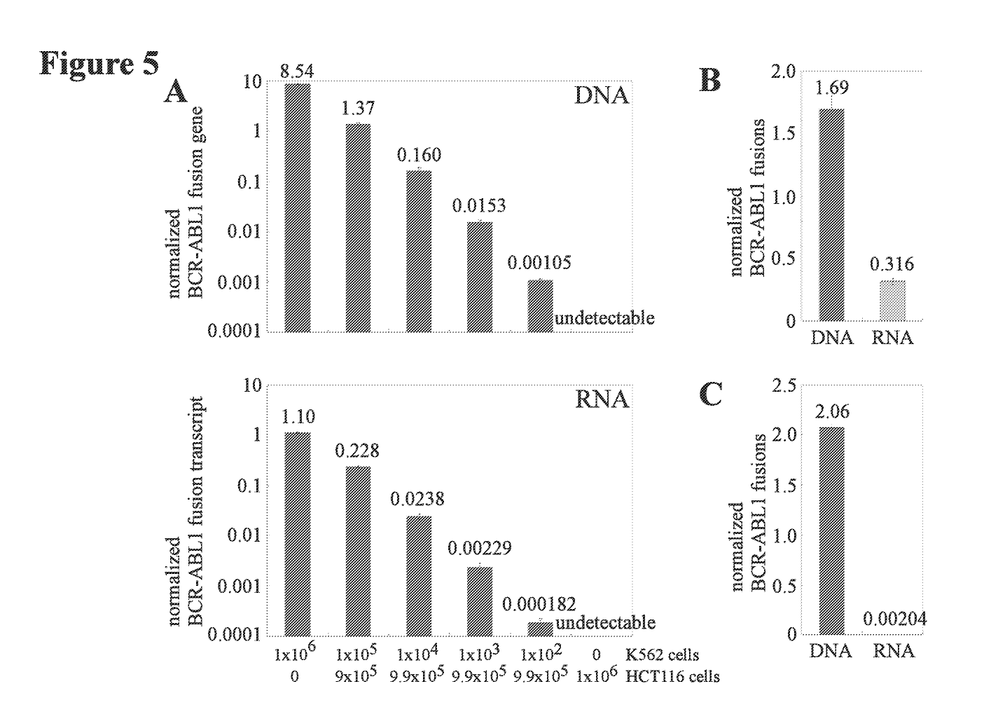

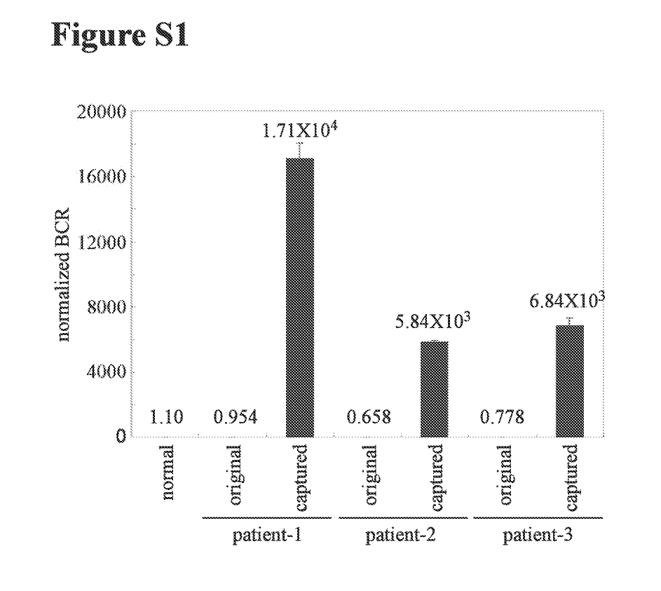

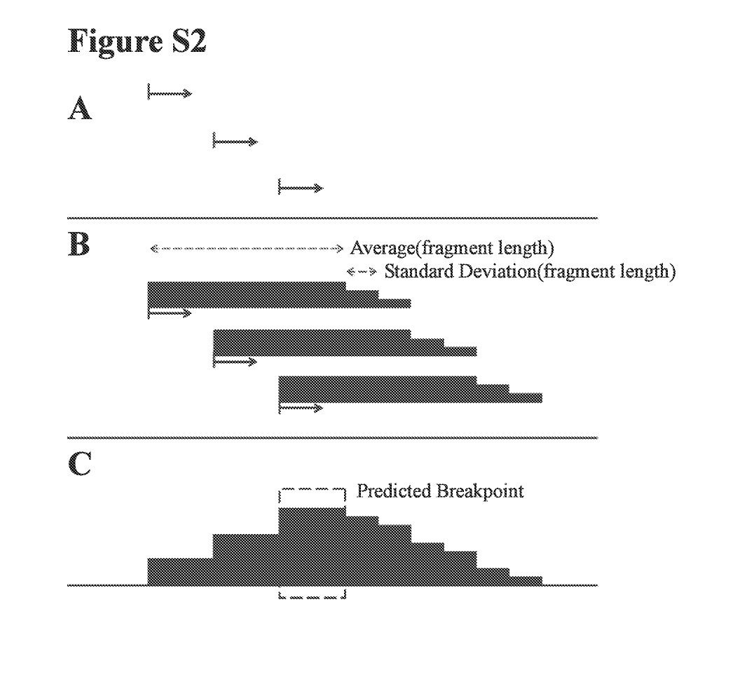

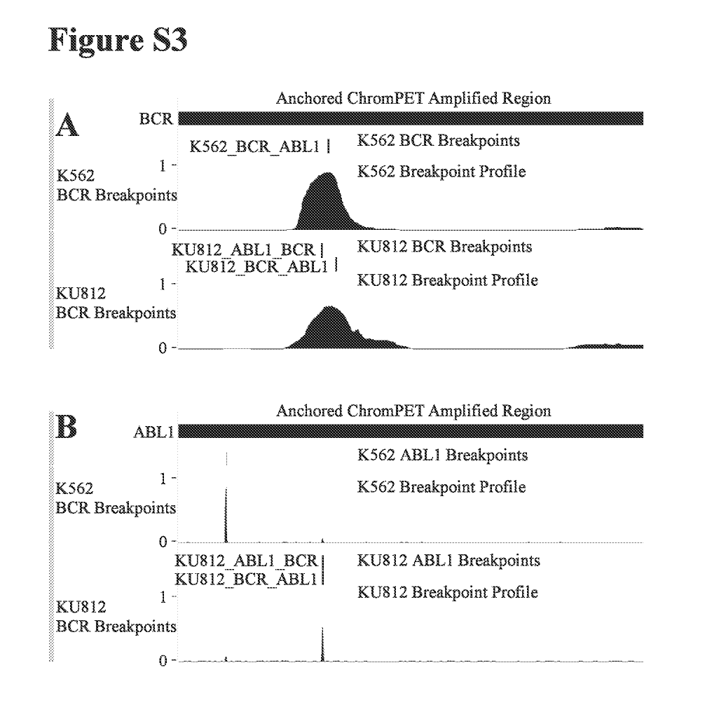

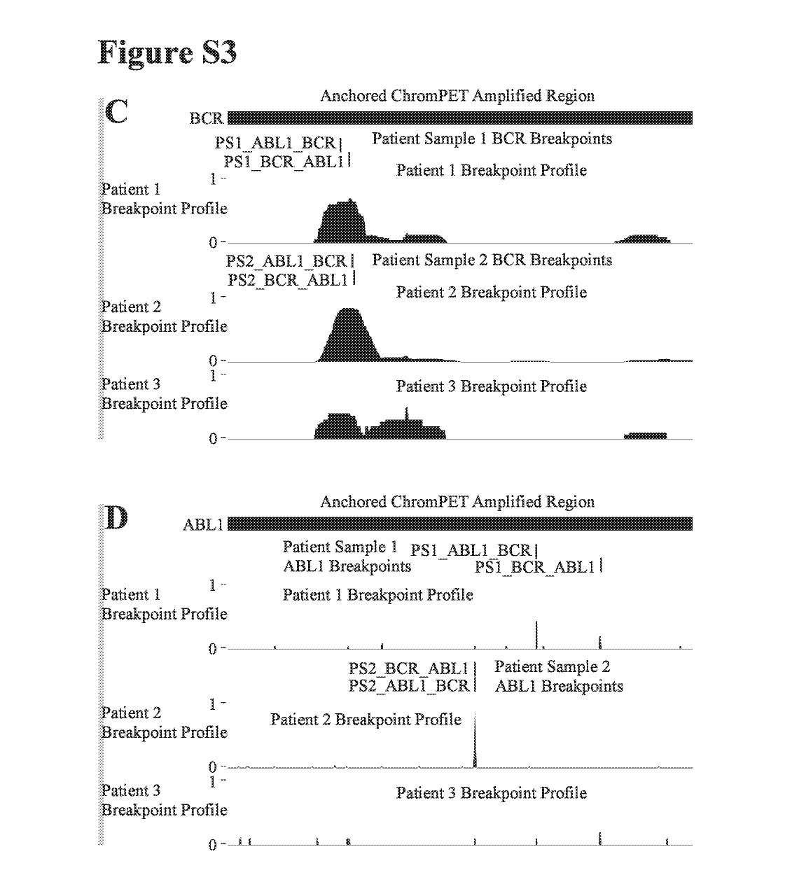

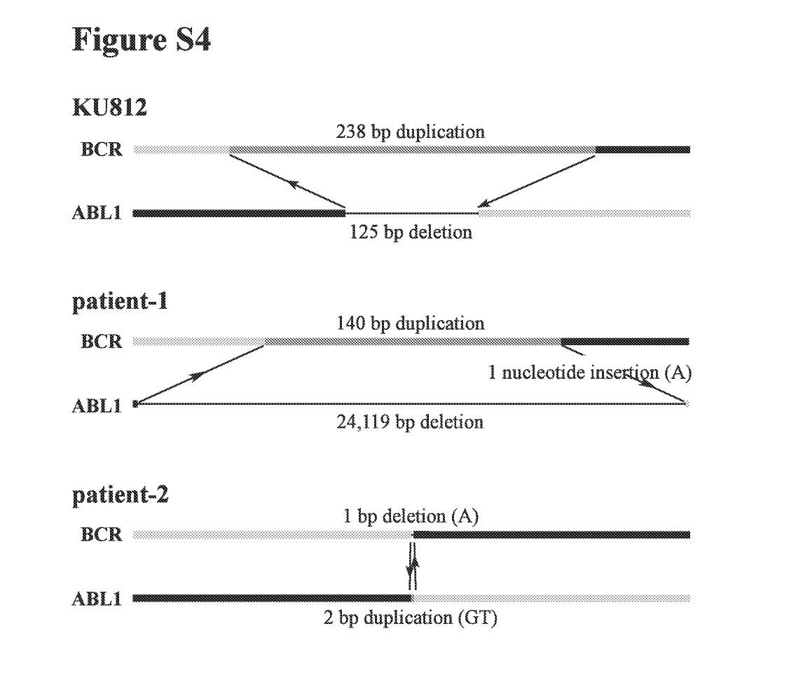

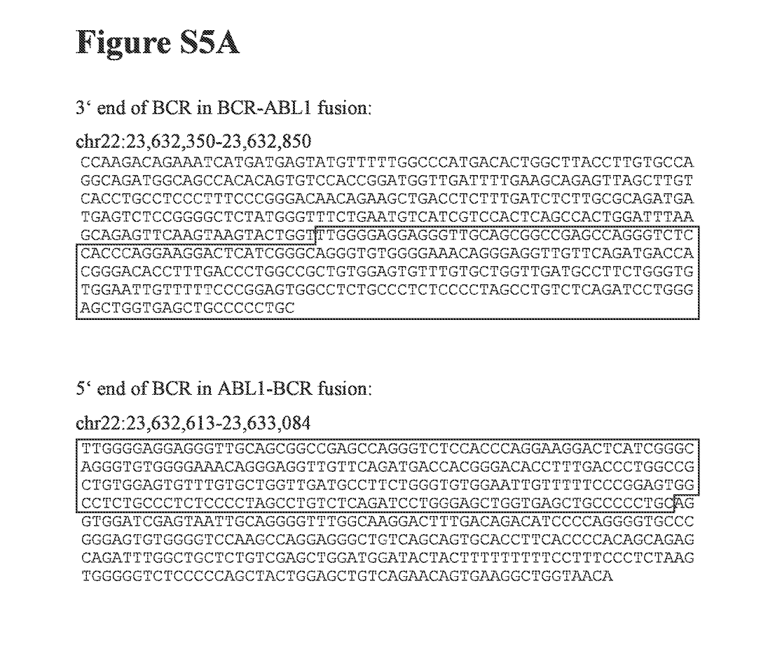

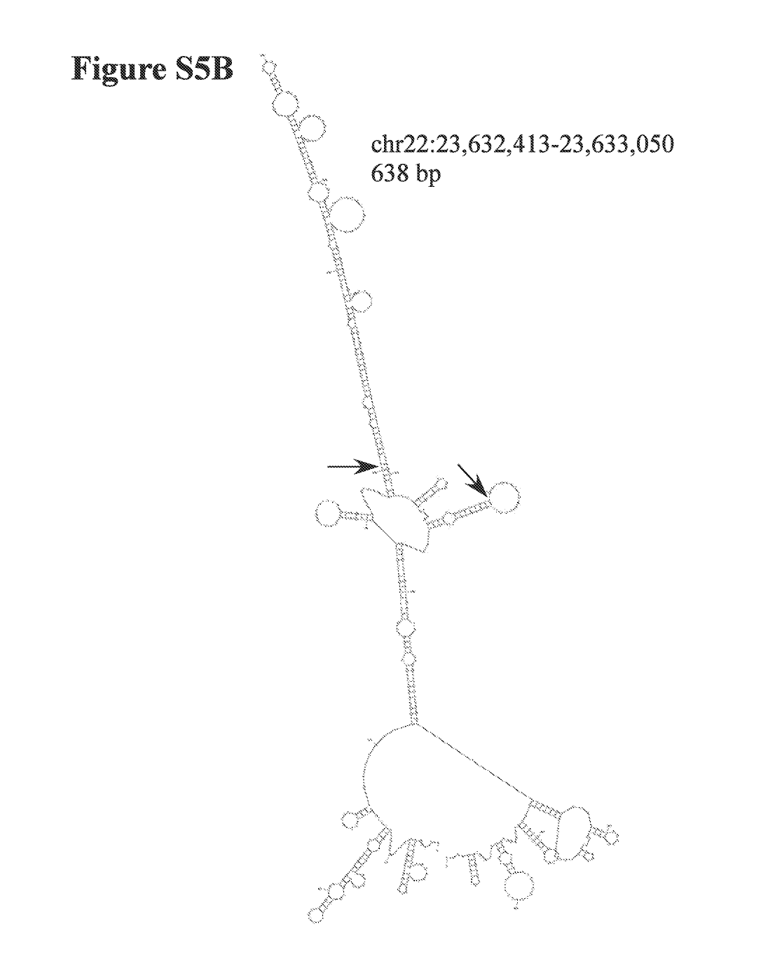

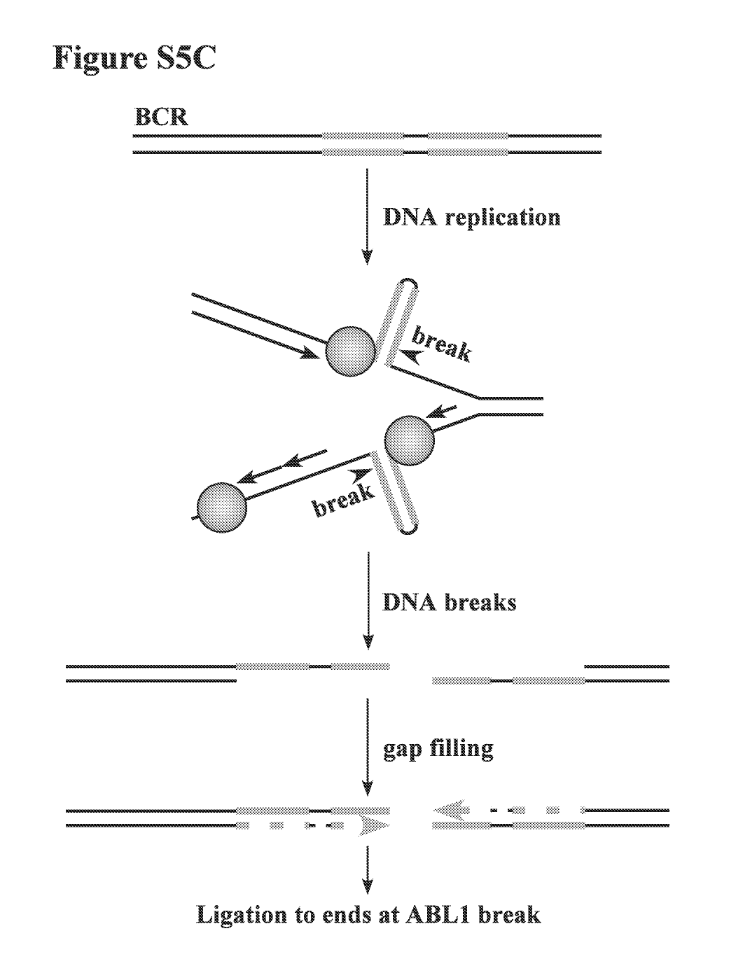

Because a clinical sample is not composed uniformly of malignant cells, we next evaluated the sensitivity of detecting the DNA-based biomarkers identified by Anchored ChromPET. A dilution series of K562 cells was created by combining with HCT116 colon cancer cells without the BCR-ABL1 translocation. As shown in FIG. 5A, we detected the BCR-ABL1 junctional DNA in 100 ng total DNA even when only 0.01% of the cells carried the BCR-ABL1 gene and this sensitivity is equivalent to the detection of the fusion transcript in 100 ng RNA by RT-PCR. The sensitivity of the RNA based RT-PCR methods for detecting BCR-ABL1 transcripts is similar to that reported in the Literature [21].

The most important benefit of Anchored ChromPET is the precise identification of the breakpoints on DNA, which allows for optimal design of PCR primers for a DNA-based biomarker of the translocation junction. It is well known that RNA is less stable than DNA because (a) the 2′-OH group of a ribonucleotide is more reactive than the 2′-H of a deoxyribonucleotide, causing RNA to break more easily and (b) RNAses are present on our body surfaces and body fluids. Formalin-fixed, paraffin-embedded (FFPE) tissue is one of the most commonly archived forms for clinical samples. DNA and RNA from FFPE samples are highly fragmented and in general, the recovery efficiency of DNA is better than that of RNA. Therefore, we evaluated the sensitivity of detection of DNA- or RNA-based junctional biomarkers in samples extracted from formalin-fixed cells. After extraction of DNA or RNA from 10,000 cells, we measured the yield of DNA or RNA junctions by quantitative real-time PCR and normalized the result to the yield from 1,000 fresh cells. As shown in FIG. 5B, five-fold more DNA biomarker than RNA biomarker was detected from formalin-fixed cells.

Finally, as cells die, they release their DNA and RNA into the body fluids and the ideal biomarker will be stable in serum at body temperature. We therefore measured the amount of DNA or RNA biomarkers that survive in serum-containing cell culture medium at 37° C. following growth of K562 cells (FIG. 5C). After filtration of medium to remove cells, we isolated DNA or RNA from 100 ul of medium and measured the amount of junctional biomarker as above. Junctional DNA was detected nearly 10,000 times more efficiently than junctional RNA (FIG. 5C), strongly suggesting that the DNA biomarkers identified by Anchored ChromPET will be of great utility for detection of the cancer-derived aberrant DNA in body fluids.

Discussion:

Advantages of Anchored ChromPET

Anchored ChromPET makes it possible to detect gene rearrangements in a targeted region in a short time and provides a personalized DNA based biomarker for following a patient's disease. This technique has the advantages of both karyotyping and RT-PCR. 25-30 metaphase cells are usually examined during karyotyping so that the sensitivity of detecting a Ph-positive cell is 3-4%. Interphase FISH can be applied to nondividing cells isolated from peripheral blood to detect the juxtaposition of BCR and ABL signals created by a translocation. In this case, about 200-500 nuclei are studied, giving a sensitivity of detection of 0.2-0.5%. However, the percentage of BCR-ABL1-positive cells in peripheral blood is lower than that of bone marrow and protein digestion step to remove chromatin proteins before FISH affect signals that are difficult to interpret. As shown Table 1, we identified 23 junctional ChromPETs from 89316 reads of patient sample 1 giving an apparent sensitivity of 0.03% for the primary detection of a BCR-ABL fusion.

We also evaluated the sensitivity of detection of the PCR product spanning the chromosome junction for molecular follow up of the disease (FIG. 5A). The sensitivity of detection of the DNA junction is at least 0.01% and is almost equivalent to that of detecting the RNA fusion. Whereas RNA degradation during sample preparation and silencing of the BCR-ABL1 affect sensitivity of detection of detection of the fusion RNA[12], the DNA junction is relatively free from these issues.

With G banding, approximately 400 to 800 bands per haploid set can be detected by a trained cytogeneticist. The haploid human genome occupies about 3×10⁹ bp. Thus, the resolution of karyotype is 5 Mb. The resolution of interphase FISH is 50-100 kb. The resolution of RT-PCR for detecting fusion transcripts is not comparable to that obtained here, because the chimeric RNA merely indicates the two exons fused to each other, when the DNA breakpoints are anywhere within the adjoining introns. In comparison, we identify the exact DNA junction at the base-pair level by Anchored ChromPET, suggesting that the sequencing based approach gives the best resolution of the DNA junction.

Anchored ChromPET, therefore, provides a high resolution digital karyotype with better sensitivity than comparable methods for detecting the DNA translocation. Note that there is no detectable signal saturation and so the sequencing step can be scaled up by sequencing more DNA to sample even rarer DNA fusion events. About 5-10% of CML patients are Ph-negative by karyotyping, but the BCR-ABL1 transcript is detectable by RT-PCR in half of these cases. In some cases ABL1 gene is inserted in the BCR locus and results in the BCR-ABL1 fusion in a cytogenetically normal chromosome 22 and vice versa [22]. Thus a significant advantage to DNA sequencing is that we can identify the specific base-pair location of even these chromosome rearrangements. While there is no doubt that CML is caused by the expression of the BCR-ABL1 fusion transcript, genetic heterogenity of the fusion junction might influence disease progression [13]. Therefore by giving higher resolution information on the breakpoint compared to an RNA-based method like RT-PCR, Anchored ChromPET may be more useful for future studies correlating the DNA breakpoint with disease progression.

Unlike karyotyping, nondividing cells isolated from peripheral blood can be used for Anchored ChromPET. There are reports in the Literature of successful isolation of 0.5-1 kb DNA fragments from blood smears and formalin fixed paraffin embedded tissue. Therefore, Anchored ChromPET and subsequent PCR detection of junctional DNA can be especially useful for retrospective analysis of patient material for both identification of the translocation and detection of minimal residual disease. How do we expect this technology to be used in the diagnosis and management of new cases of CML? Most patients present as Chronic phase CML, characterized by leukocytosis with the presence of precursor cells of the myeloid lineage. There are normally between 4×10⁹ and 1.1×10¹⁰ white blood cells in a liter of blood, but this number is significantly increased with up to 10% blast cells and promyelocytes in the blood in chronic phase CML. In acute phase CML >70-80% of white blood cells in the peripheral blood can be blasts. RT-PCR seems to be the easiest and most sensitive molecular method for detection of the BCR-ABL transcript in both these situations. Despite this, karyotyping of the bone marrow (or at least interphase FISH of peripheral blood) to detect the fusion at the DNA level is considered the gold standard for the diagnosis. We propose that Anchored ChromPET is an alternative for detecting the DNA fusion. 1 ml of blood is enough to construct ChromPET library for the identification of the breakpoint, and once a breakpoint is identified PCR will be able to detect gene rearrangements with the same volume of blood. The whole 135 kb of the BCR gene can be used as a bait, and the resulting 21× increase in sequencing is still well within the capability of one-tenth of a lane of a Solexa sequencer, which yields 10-20 million reads per lane. An alternative strategy is to use the results of the RT-PCR to define exactly which exon of BCR flanks the DNA fusion, and then design a smaller bait that will capture the adjoining intron and junctional DNA fragments to sequence the DNA breakpoint.

A major advantage of Anchored ChromPET is that we do not have to grow the cells in culture and so the method is expected to find wide application in searching for specific translocations for solid cancers where it is difficult to grow all the cancer cells in culture. In addition, since the sensitivity of the method can be increased by sequencing more DNA fragments, we expect it to reliably detect translocations carried by even a small fraction of the cells in a sample. Finally, for translocations (unlike BCR-ABL) where methods have not been standardized to detect the various alternative fusion transcripts by RT-PCR, Anchored ChromPET can become the method of choice for detecting the DNA fusion that defines the translocation.

Only future experiments will define whether the DNA fusion or the RNA fusion will be the better marker for minimal residual diseases or early recurrence. However, since the detection of the DNA fusion does not need reverse transcription and is not as susceptible to the factors that degrade RNA, we anticipate that the DNA fusion fragment may be a more sensitive biomarker than the RNA fusion fragment. We could easily detect the DNA junctional fragment in filtered cell culture medium, suggesting that DNA derived from dead cells survives in serum at 37° C. for an extended period of time. In contrast, it is hard to detect the RNA fusion transcript in the same cell culture medium. This observation suggests that another potential advantage of using the DNA junctional fragment as a biomarker is that it may survive as free nucleic acid in body fluids like blood or even urine. This, again, is something that we are interested in testing in the future.

The decrease in sequencing achieved by anchoring, by sampling only the ends of the fragments and by multiplexing multiple samples in the same lane of a sequencer brings the costs of sequencing down considerably. In our estimate, considering the current state of sequencing capabilities and the small number of sequences necessary to identify the breakpoint, we can reliably multiplex up to 10 samples in a single lane of the Illumina sequencer, making the sequencing costs much lower than whole genome sequencing for identifying cancer-specific recombination biomarkers.

Computational Prediction of Breakpoint

Table 2 shows the coordinates of the predicted breakpoints, the coordinates of the sequenced breakpoints and the difference (in base-pairs) between them. For the BCR breakpoint in patient 2 cells and ABL1 breakpoints in K562 cell line and patient 1 and 2, the predictions turned out to match exactly to the sequenced breakpoint. Even in other cases, the maximum difference is only 144 bp. In the BCR-ABL1 fusion in patient 1, a >20 kb deletion in the ABL1 locus (FIG. S4) produced two discrete breakpoint predictions in the ABL1 locus (FIG. S3D) with one corresponding to the BCR-ABL1 fusion and the other to the ABL1-BCR fusion.

These results demonstrate that the predictions from our algorithm match reasonably well to the breakpoints verified by experimental methods. Our results also suggest that breakpoints could be predicted using even a small number of junctional ChromPETs (K562 and Patient sample 1). However, we could not predict a consensus breakpoint from patient sample 3 and could not PCR a junctional fragment from this DNA. So even though there are junctional ChromPETs that were assigned to Patient-3, these are most likely the result of contamination during ChromPET library construction. The fact that the contamination did not lead to a false positive call, points to the robustness of the approach.

Other Methods for Sequencing the DNA Translocation Junction

Ligation of a special adaptor to the ends of genomic DNA fragments, PCR cycles beginning with an exon of BCR, followed by nested PCR starting with the adaptor, has been used to clone and sequence several BCR-ABL junctions [23]. In another approach, 6 forward primers were used to cover 3 kb of the M-BCR gene and 302 reverse primers were used to cover 150 kb of the ABL gene to PCR potential junctions with clever adaptations to remove non-specific PCR products [24]. Both these methods, however, can only be used when we know that the breakpoint is close (within a distance suitable for PCR) to a limited part of the BCR gene. In comparison, Anchored ChromPET was used in this paper to identify a breakpoint anywhere in the 6 kb M-Bcr region and can be readily scaled up to screen for breakpoints in the entire 135 kb BCR gene. The breakpoint on the other side can be anywhere in the ABL gene (of for that matter, anywhere else in the genome). Furthermore, as demonstrated here, the method often yields the reciprocal ABL-BCR junction.

RNA Bait Preparation

Well-designed RNA baits useful for the capture of DNA fragments can be commercially synthesized [25]. However, such baits are very expensive, and will be even more expensive if larger parts of the genome need to be anchored. For example, in this paper, we used the 6.6 kb region containing M-bcr in chromosome 22q11 as the anchoring DNA, because >90% of CML BCR breakpoints are in this region. However breakpoints in minor breakpoint cluster region (m-bcr) are seen in ALLs, and are dotted over 90 kb region in intron 1 of BCR gene. The different method of bait preparation described in this paper is cost-efficient and can be scaled up to cover the 135 kb whole BCR gene, which will allow us to identify rare breakpoints in m-bcr or micro-bcr and also to definitively rule out translocations anywhere in the BCR gene.

Translocation Junctions

Detection of both reciprocal translocations in KU812 and two patient samples allowed us to analyze what happens to the ends of the chromosomes after the break that initiates the translocation. For the ABL1 locus in all samples and for BCR1 in patient 2 some DNA sequence is lost most likely due to exonuclease activity before ligation (FIG. S4).

In contrast, in KU812 cells and in patient 1, some of the DNA at the BCR locus seems to be duplicated, so that the BCR breakpoint in the BCR-ABL fusion is downstream from the BCR breakpoint in the ABL-BCR fusion. (FIGS. S3, S4, and S5A). This kind of duplication is often observed in balanced chromosome rearrangements [26]. DNA mfold [27] predicts that the DNA around the BCR breakpoints in KU812 forms a stem-loop structure with a Gibbs free energy (dG) of −88.96 kcal/mol (FIG. S5B). Hairpin- or cruciform-like DNA structure are strongly associated with genomic instability by interfering with DNA replication in both prokaryotes and eukaryotes. It is hypothesized that formation of stable secondary DNA structure in this region is responsible for breakpoint in M-bcr [28-30]. If the cruciform breaks at different points on the two strands of BCR, the resulting 3′ overhang on each strand could be blunted by continued polymerase action (FIG. 5C) leading to the duplication of DNA from the BCR locus. Such a cruciform structure, however, was not detected around the duplicated region in patient 1, so that this may not be the only mechanism for the duplication.

### CONCLUSIONS

The detection of BCR-ABL1 fusion gene is critical for the diagnosis of chronic myeloid leukemia and for following the progress of the patients after therapy. Currently, karyotyping or interphase FISH is considered the gold standard for diagnosis of specific chromosomal translocations. Compared to these methods, paired-end sequencing is highly sensitive for detecting chromosomal translocations, has high resolution, and lends itself to high throughput automation. However, genome-wide sequencing to detect BCR-ABL1 translocation is too expensive. Therefore, we made genomic DNA libraries with adapters including bar code and captured major break cluster region in the BCR gene from whole genomic DNA. Using paired-end sequencing of such captured libraries we can identify the exact breakpoints in BCR and ABL1 gene in two cell lines and two chronic myeloid leukemia patients. We also show that detection of the DNA junctional fragment is comparable in sensitivity to the detection of the RNA fusion transcript by RT-PCR if the RNA is harvested and stored under carefully controlled laboratory conditions. Under non-ideal conditions, such as from formalin-fixed cells or from cell-free nucleic acids in serum, the DNA junctional fragment is more stable and is detected at higher sensitivity. This approach of “anchored chromosomal paired-end tags” is an efficient way for the detecting BCR-ABL1 and potentially useful for many other chromosomal translocations currently identified by cytogenetics. It has the added advantage of providing a DNA based biomarker for the translocation that can be used for follow-up of the patient.

### BIBLIOGRAPHY

1. Sessions J: Chronic myeloid leukemia in 2007. Am J Health Syst Pharm 2007, 64:S4-9.
2. Quintas-Cardama A, Cortes J: Molecular biology of bcr-abl1-positive chronic myeloid leukemia. Blood 2009, 113:1619-1630.
3. Wong S, Witte O N: The BCR-ABL story: bench to bedside and back. Annu Rev Immunol 2004, 22:247-306.
4. Druker B J: Translation of the Philadelphia chromosome into therapy for CML. Blood 2008, 112:4808-4817.
5. Goldman J M, Melo J V: BCR-ABL in chronic myelogenous leukemia—how does it work? Acta Haematol 2008, 119:212-217.
6. Hughes T, Deininger M, Hochhaus A, Branford S, Radich J, Kaeda J, Baccarani M, Cortes J, Cross N C, Druker B J, Gabert J, Grimwade D, Hehlmann R, Kamel-Reid S, Lipton J H, Longtine J, Martinelli G, Saglio G, Soverini S, Stock W, Goldman J M: Monitoring CML patients responding to treatment with tyrosine kinase inhibitors: review and recommendations for harmonizing current methodology for detecting BCR-ABL transcripts and kinase domain mutations and for expressing results. Blood 2006, 108:28-37.
7. Costa D, Espinet B, Queralt R, Carrio A, Sole F, Colomer D, Cervantes F, Hernandez J A, Besses C, Campo E: Chimeric BCR/ABL gene detected by fluorescence in situ hybridization in three new cases of Philadelphia chromosome-negative chronic myelocytic leukemia. Cancer Genet Cytogenet 2003, 141:114-119.
8. Fugazza G, Garuti A, Marchelli S, Miglino M, Bruzzone R, Gatti A M, Castello S, Sessarego M: Masked Philadelphia chromosome due to atypical BCR/ABL localization on the 9q34 band and duplication of the der(9) in a case of chronic myelogenous leukemia. Cancer Genet Cytogenet 2005, 163:173-175.
9. Mark H F, Sokolic R A, Mark Y: Conventional cytogenetics and FISH in the detection of BCR/ABL fusion in chronic myeloid leukemia (CML). Exp Mol Pathol 2006, 81:1-7.
10. Virgili A, Brazma D, Reid A G, Howard-Reeves J, Valganon M, Chanalaris A, De Melo V A, Marin D, Apperley J F, Grace C, Nacheva E P: FISH mapping of Philadelphia negative BCR/ABL1 positive CML. Mol Cytogenet 2008, 1:14.
11. Foroni L, Gerrard G, Nna E, Khorashad J S, Stevens D, Swale B, Milojkovic D, Reid A, Goldman J, Marin D: Technical aspects and clinical applications of measuring BCR-ABL1 transcripts number in chronic myeloid leukemia. Am J Hematol 2009, 84:517-522.
12. Mattarucchi E, Spinelli O, Rambaldi A, Pasquali F, Lo Curto F, Campiotti L, Porta G: Molecular monitoring of residual disease in chronic myeloid leukemia by genomic DNA compared with conventional mRNA analysis. J Mol Diagn 2009, 11:482-487.
13. Sinclair P B, Nacheva E P, Leversha M, Telford N, Chang J, Reid A, Bench A, Champion K, Huntly B, Green A R: Large deletions at the t(9;22) breakpoint are common and may identify a poor-prognosis subgroup of patients with chronic myeloid leukemia. Blood 2000, 95:738-743.
14. Shibata Y, Malhotra A, Bekiranov S, Dutta A: Yeast genome analysis identifies chromosomal translocation, gene conversion events and several sites of Ty element insertion. Nucleic Acids Res 2009, 37:6454-6465.
15. Stephens P J, McBride D J, Lin M L, Varela I, Pleasance E D, Simpson J T, Stebbings L A, Leroy C, Edkins S, Mudie L J, Greenman C D, Jia M, Latimer C, Teague J W, Lau K W, Burton J, Quail M A, Swerdlow H, Churcher C, Natrajan R, Sieuwerts A M, Martens J W, Silver D P, Langerod A, Russnes H E, Foekens J A, Reis-Filho J S, van 't Veer L, Richardson A L, Borresen-Dale A L, Campbell P J, Futreal P A, Stratton M R: Complex landscapes of somatic rearrangement in human breast cancer genomes. Nature 2009, 462:1005-1010.
16. Maher C A, Palanisamy N, Brenner J C, Cao X, Kalyana-Sundaram S, Luo S, Khrebtukova I, Barrette T R, Grasso C, Yu J, Lonigro R J, Schroth G, Kumar-Sinha C, Chinnaiyan A M: Chimeric transcript discovery by paired-end transcriptome sequencing. Proc Natl Acad Sci USA 2009, 106:12353-12358.
17. Fullwood M J, Wei C L, Liu E T, Ruan Y: Next-generation DNA sequencing of paired-end tags (PET) for transcriptome and genome analyses. Genome Res 2009, 19:521-532.
18. Ng P, Wei C L, Ruan Y: Paired-end diTagging for transcriptome and genome analysis. Curr Protoc Mol Biol 2007, Chapter 21:Unit 21.12.
19. Dugan L C, Pattee M S, Williams J, Eklund M, Sorensen K, Bedford J S, Christian A T: Polymerase chain reaction-based suppression of repetitive sequences in whole chromosome painting probes for FISH. Chromosome Res 2005, 13:27-32.
20. Ross D M, Schafranek L, Hughes T P, Nicola M, Branford S, Score J: Genomic translocation breakpoint sequences are conserved in BCR-ABL1 cell lines despite the presence of amplification. Cancer Genet Cytogenet 2009, 189:138-139.
21. Zhang J G, Lin F, Chase A, Goldman J M, Cross N C: Comparison of genomic DNA and cDNA for detection of residual disease after treatment of chronic myeloid leukemia with allogeneic bone marrow transplantation. Blood 1996, 87:2588-2593.
22. Nacheva E, Holloway T, Brown K, Bloxham D, Green A R: Philadelphia-negative chronic myeloid leukaemia: detection by FISH of BCR-ABL fusion gene localized either to chromosome 9 or chromosome 22. Br J Haematol 1994, 87:409-412.
23. Mattarucchi E, Guerini V, Rambaldi A, Campiotti L, Venco A, Pasquali F, Lo Curto F, Porta G: Microhomologies and interspersed repeat elements at genomic breakpoints in chronic myeloid leukemia. Genes Chromosomes Cancer 2008, 47:625-632.
24. Bartley P A, Martin-Harris M H, Budgen B J, Ross D M, Morley A A: Rapid isolation of translocation breakpoints in chronic myeloid and acute promyelocytic leukaemia. Br J Haematol 2010, 149:231-236.
25. Gnirke A, Melnikov A, Maguire J, Rogov P, LeProust E M, Brockman W, Fennell T, Giannoukos G, Fisher S, Russ C, Gabriel S, Jaffe D B, Lander E S, Nusbaum C: Solution hybrid selection with ultra-long oligonucleotides for massively parallel targeted sequencing. Nat Biotechnol 2009, 27:182-189.
26. Chen W, Ullmann R, Langnick C, Menzel C, Wotschofsky Z, Hu H, Doring A, Hu Y, Kang H, Tzschach A, Hoeltzenbein M, Neitzel H, Markus S, Wiedersberg E, Kistner G, van Ravenswaaij-Arts C M, Kleefstra T, Kalscheuer V M, Ropers H H: Breakpoint analysis of balanced chromosome rearrangements by next-generation paired-end sequencing. Eur J Hum Genet. 2009, 18:539-543.
27. Zuker M: Mfold web server for nucleic acid folding and hybridization prediction. Nucleic Acids Res 2003, 31:3406-3415.
28. Voineagu I, Narayanan V, Lobachev K S, Mirkin S M: Replication stalling at unstable inverted repeats: interplay between DNA hairpins and fork stabilizing proteins. Proc Natl Acad Sci USA 2008, 105:9936-9941.
29. Inagaki H, Ohye T, Kogo H, Kato T, Bolor H, Taniguchi M, Shaikh T H, Emanuel B S, Kurahashi H: Chromosomal instability mediated by non-B DNA: cruciform conformation and not DNA sequence is responsible for recurrent translocation in humans. Genome Res 2009, 19:191-198.
30. Leach D R: Long DNA palindromes, cruciform structures, genetic instability and secondary structure repair. Bioessays 1994, 16:893-900.

The disclosures of each and every patent, patent application, and publication cited herein are hereby incorporated by reference herein in their entirety.

Headings are included herein for reference and to aid in locating certain sections. These headings are not intended to limit the scope of the concepts described therein under, and these concepts may have applicability in other sections throughout the entire specification.

While this invention has been disclosed with reference to specific embodiments, it is apparent that other embodiments and variations of this invention may be devised by others skilled in the art without departing from the true spirit and scope of the invention.

1. A method for identifying a structural variation in a chromosome, said method comprising:
a. constructing a ChromPET library from a DNA sample, fragmenting said DNA, and adding a Y-shaped adapter with a bar code to both ends of said fragments wherein paired-end tags are formed;
b. preparing RNA bait;
c. heat denaturing said ChromPET library DNA and hybridizing said ChromPET library DNA to said RNA bait;
d. capturing said RNA-DNA hybrid;
e. washing away said RNA, converting annealed DNA to double-stranded DNA, and sequencing said DNA, forming an Anchored ChromPET library;
f. identifying said ChromPETs from said Anchored ChromPET library using the bar code of the paired-end tags;
g. mapping said ChromPETs from said Anchored ChromPET library to a targeted sequence region, extracting a sequence of interest, and indexing said sequence of interest;
h. classifying said ChromPETs from said Anchored ChromPET library as normal or aberrant ChromPETs, wherein said aberrant ChromPET is optionally a junctional ChromPET;
i. mapping said junctional ChromPETs to the genome; and
j. predicting chromosomal breakpoints, thereby identifying a structural variation in a chromosome.

2. The method of claim 1, wherein said DNA sequencing is high-throughput sequencing.

3. The method of claim 1, wherein said ChromPET library fragments are about 0.5 kb.

4. The method of claim 1, wherein said identified ChromPETs from said Anchored ChromPET library are identified based on paired-end tag reads obtained from a sequencer.

5. The method of claim 4, wherein said identified ChromPETs are mapped to a target region using an alignment program.

6. The method of claim 1, wherein said sequence of interest is indexed with an indexing program.

7. The method of claim 1, wherein said breakpoint is predicted using an algorithm.

8. The method of claim 7, wherein said algorithm is based on a voting procedure.

9. The method of claim 8, wherein each tag of a junctional ChromPET votes on the location of the actual breakpoint and normal ChromPETs are used to estimate average and standard deviation of fragment lengths.

10. The method of claim 9, wherein when each tag of a junctional ChromPET votes on the location of the actual breakpoint, a vote of 3 is to the interval that is the average fragment length downstream from the start of the tag, a vote of 2 is to the interval one standard deviation down from the end of the 3 zone, and a vote of 1 is to the interval another standard deviation downstream from the 2 zone, further wherein all votes are totaled and plotted over a locus of interest, and the region with the maximum votes contains the predicted breakpoint.

11. The method of claim 10, wherein said locus of interest is selected from the group consisting of BCR and ABL.

12. The method of claim 1, wherein the normal ChromPETs are selected from the group consisting of BCR-BCR and ABL1-ABL-1.

13. The method of claim 1, wherein the junctional ChromPETs are associated with a disease or disorder.

14-16. (canceled)

17. The method of claim 16, wherein the junctional ChromPET sequences for ABL1-BCR and BCR-ABL1 are selected from the group consisting of SEQ ID NOs:35-41.

18. The method of claim 1, wherein said structural variation is selected from the group consisting of rearrangement, deletion, insertion, translocation, and copy number change.

19. The method of claim 1, wherein said chromosome is a mammalian chromosome.

20. The method of claim 19, wherein the mammal is a human.

21. A method for diagnosing a disease or disorder in a subject, said method comprising identifying a structural variation in a chromosome of a test subject according to the method of claim 1, wherein said structural variation is associated with said disease or disorder, thereby diagnosing a disease or disorder in a subject.

22-24. (canceled)

25. A method for monitoring the progression of a disease or disorder in a subject wherein said disease or disorder is associated with a structural variation in a chromosome, said method comprising measuring the level of said structural variation in a sample from a test subject according to the method of claim 1, comparing said level in said test subject to the level of said structural variation in an otherwise identical sample obtained earlier from said test subject or from an unaffected subject, or to a standard sample, thereby monitoring the progression of a disease or disorder in a subject.

26-29. (canceled)

30. The method of claim 25, wherein a higher level of said structural variation in said test subject compared to the level in an otherwise identical sample obtained earlier from said test subject or from an unaffected subject, or to a standard sample, is an indication that said disease or disorder is progressing.

31. The method of claim 25, wherein a lower level of said structural variation in said test subject compared to the level in an otherwise identical sample obtained earlier from said test subject or from an unaffected subject, or to a standard sample, is an indication that said disease or disorder is regressing.

32. A kit for identifying and measuring a structural variation in a chromosome, said kit comprising: a list of reagents for pre-treatment of selected DNA sites for anchoring; polymerase chain reaction reagents; primer sequences; a list of reagents for sequencing; instructions and reagents for making the DNA library for paired end tag sequencing; DNA sequence based bar codes to distinguish libraries from different patients; list of materials for computational platform; algorithm for searching the ChromPET sequences to identify translocation junctions; primers to PCR amplify the translocation junction and sequence the junctional fragments for confirmation; and an instructional material for the use thereof.


SEQUENCE LISTING (43 sequences)

SEQ ID NO: 1 - DNA, 16 bp, homo sapiens
gtaaaacgacggccag

SEQ ID NO: 2 - DNA, 17 bp, homo sapiens
caggaaacagctatgac

SEQ ID NO: 3 - DNA, 25 bp, homo sapiens
caggccctttccagattccacacct

SEQ ID NO: 4 - DNA, 25 bp, homo sapiens
ccccaagggagaagggaagtccagt

SEQ ID NO: 5 - DNA, 25 bp, homo sapiens
cccagggtttcctgtcataacatag

SEQ ID NO: 6 - DNA, 24 bp, homo sapiens
gtgaggaaaaggggcttatttctg

SEQ ID NO: 7 - DNA, 25 bp, homo sapiens
tccactcagccactggatttaagca

SEQ ID NO: 8 - DNA, 25 bp, homo sapiens
ggtgaattggaaagaagcagcaggt

SEQ ID NO: 9 - DNA, 24 bp, homo sapiens
aaacagggaggttgttcagatgac

SEQ ID NO: 10 - DNA, 25 bp, homo sapiens
aagggtatttctgtttgggtatgga

SEQ ID NO: 11 - DNA, 25 bp, homo sapiens
gaatgtcatcgtccactcagccact

SEQ ID NO: 12 - DNA, 25 bp, homo sapiens
ttgttgtgcagaattcccaccagtc

SEQ ID NO: 13 - DNA, 20 bp, homo sapiens
ccttctgggtgtggaattgt

SEQ ID NO: 14 - DNA, 25 bp, homo sapiens
tcactttcttctgcatgaaacttta

SEQ ID NO: 15 - DNA, 20 bp, homo sapiens
atgggactagtggactttgg

SEQ ID NO: 16 - DNA, 27 bp, homo sapiens
gtctttactacaaatacaaaaatcagc

SEQ ID NO: 17 - DNA, 25 bp, homo sapiens
tgccttcaaagttcatttgggaaaa

SEQ ID NO: 18 - DNA, 25 bp, homo sapiens
agtggctgagtggacgatgacattc

SEQ ID NO: 19 - DNA, 25 bp, homo sapiens
caagctgttttgcattcactgttgc

SEQ ID NO: 20 - DNA, 25 bp, homo sapiens
gtcttgaacttctggggctcaagtg

SEQ ID NO: 21 - DNA, 25 bp, homo sapiens
ttcaacccacaaggagctcacagtc

SEQ ID NO: 22 - DNA, 25 bp, homo sapiens
aaggcatcaaccagcacaaacactc

SEQ ID NO: 23 - DNA, 25 bp, homo sapiens
agcattccgctgaccatcaataagg

SEQ ID NO: 24 - DNA, 25 bp, homo sapiens
ggccacaaaatcatacagtgcaacg

SEQ ID NO: 25 - DNA, 25 bp, homo sapiens
gtggtcgttgtctttctaggtctca

SEQ ID NO: 26 - DNA, 25 bp, homo sapiens
ggaaggaggaaagtctagctggttt

SEQ ID NO: 27 - DNA, 58 bp, homo sapiens
aatgatacggcgaccaccgagatctacactctttccctacacgacgctcttccgatct

SEQ ID NO: 28 - DNA, 61 bp, homo sapiens
caagcagaagacggcatacgagatcggtctcggcattcctgctgaaccgctcttccgatct

SEQ ID NO: 29 - DNA, 36 bp, homo sapiens
tcgagatcggaagagcggttcagcaggaatgccgag

SEQ ID NO: 30 - DNA, 37 bp, homo sapiens
tagctctagccttctcgcagcacatccctttctcaca

SEQ ID NO: 31 - DNA, 36 bp, homo sapiens
gctagatcggaagagcggttcagcaggaatgccgag

SEQ ID NO: 32 - DNA, 37 bp, homo sapiens
tcgatctagccttctcgcagcacatccctttctcaca

SEQ ID NO: 33 - DNA, 36 bp, homo sapiens
accagatcggaagagcggttcagcaggaatgccgag

SEQ ID NO: 34 - DNA, 37 bp, homo sapiens
ttggtctagccttctcgcagcacatccctttctcaca

SEQ ID NO: 35 - DNA, 180 bp, homo sapiens
gcagcggccgagccagggtctccacccaggaaggactcatcgggcagggtgtggggaaacagggaggttgttcagatgaccacgggacacctttgaccctggccgctgtggagtgggttttatcagcttccatacccaaacagaaatacccttaaggattttcttctctgattgcactaa

SEQ ID NO: 36 - DNA, 180 bp, homo sapiens
ggagtgtttgtgctggttgatgccttctgggtgtggaattgtttttcccggagtggcctctgccctctcccctagcctgtctcagatcctgggagctggtgagctgccccctgcttaaacagaaatggccacctgcatttgagaaaataaagtttcatgcagaagaaagtgacatgttaa

SEQ ID NO: 37 - DNA, 180 bp, homo sapiens
attacaggcaggagccactgtgcccggcctgacctcatatttgaataccgagttttagttctggaggagctgcaggttttatttggggaggagggttgcagcggccgagccagggtctccacccaggaaggactaatcgggcagggtgtggggaaacagggaggttgttcagatgaccac

SEQ ID NO: 38 - DNA, 112 bp, homo sapiens
accccgaccccctctgctgtccttggaaccttattacacttcgagtcactggtttgcctgtattgtgaaaccaacaccatgcccggctgatttttgtatttgtagtaaagac

SEQ ID NO: 39 - DNA, 179 bp, homo sapiens
tgccttcaaagttcatttgggaaaattattttcaacctagaattctatacccagacaaactgtcaagatagaagaaaggtatttttttagacatgcaccctccctgctcagtcacacacacagcatacgctatgcacatgtgtccacacacaccccacccacatcccacatcaccccga

SEQ ID NO: 40 - DNA, 180 bp, homo sapiens
ttggaaccttattacacttcgagtcactggtttgcctgtattgtgaaaccaactggatcctgagatccccaagacagaaatcatgatgagtatgtttttggcccgtaccaataaggcttgtatcccagagaactccatattgcatttaagcttgttagtaagccaggccagctctatttc

SEQ ID NO: 41 - DNA, 180 bp, homo sapiens
tgcctttatggtaagataaatctgccttggagtcaatccaaggtgatttaattactgtaggtagttgttgacactggcttaccttgtgccaggcagatggcagccacacagtgtccaccggatggttgattttgaagcagagttagcttgtcacctgcctccctttcccgggacaacaga

SEQ ID NO: 42 - DNA, 501 bp, homo sapiens
ccaagacagaaatcatgatgagtatgtttttggcccatgacactggcttaccttgtgccaggcagatggcagccacacagtgtccaccggatggttgattttgaagcagagttagcttgtcacctgcctccctttcccgggacaacagaagctgacctctttgatctcttgcgcagatgatgagtctccggggctctatgggtttctgaatgtcatcgtccactcagccactggatttaagcagagttcaagtaagtactggtttggggaggagggttgcagcggccgagccagggtctccacccaggaaggactcatcgggcagggtgtggggaaacagggaggttgttcagatgaccacgggacacctttgaccctggccgctgtggagtgtttgtgctggttgatgccttctgggtgtggaattgtttttcccggagtggcctctgccctctcccctagcctgtctcagatcctgggagctggtgagctgccccctgc

SEQ ID NO: 43 - DNA, 472 bp, homo sapiens
ttggggaggagggttgcagcggccgagccagggtctccacccaggaaggactcatcgggcagggtgtggggaaacagggaggttgttcagatgaccacgggacacctttgaccctggccgctgtggagtgtttgtgctggttgatgccttctgggtgtggaattgtttttcccggagtggcctctgccctctcccctagcctgtctcagatcctgggagctggtgagctgccccctgcaggtggatcgagtaattgcaggggtttggcaaggactttgacagacatccccaggggtgcccgggagtgtggggtccaagccaggagggctgtcagcagtgcaccttcaccccacagcagagcagatttggctgctctgtcgagctggatggatactactttttttttcctttccctctaagtgggggtctcccccagctactggagctgtcagaacagtgaaggctggtaaca